(19) United States
(12) Patent Application Publication
(10) Pub. No.: US 2015/0155554 A1
(43) Pub. Date: Jun. 4, 2015

(54) ACTIVE MATERIAL OF LITHIUM ION SECONDARY BATTERY AND LITHIUM ION SECONDARY BATTERY USING THE SAME

(71) Applicant: Panasonic Intellectual Property Management Co., Ltd., Osaka (JP)

(72) Inventors: YUTA SUGIMOTO, Osaka (JP); TOSHIRO KUME, Hyogo (JP); SATORU OHUCHI, Osaka (JP); TAKASHI KOUZAKI, Osaka (JP)

(21) Appl. No.: 14/550,752

(22) Filed: Nov. 21, 2014

(30) Foreign Application Priority Data
Nov. 29, 2013 (JP) 2013-247167
Nov. 29, 2013 (JP) 2013-247168

(51) Int. Cl. H01M 4/485; H01M 10/0525

(52) U.S. Cl. CPC H01M 4/485; H01M 10/0525; H01M 2004/027

(57) ABSTRACT

An active material of a lithium ion secondary battery includes a composition represented by W(x)Me₁(z₁)Me₂(z₂) . . . Meₙ(zₙ)O₂ (where x+z₁+z₂+ . . . +zₙ=1, n is an integer of 1 or more, and 0<max{z₁, z₂, . . . , zₙ}/x<1/2) or W(x)Mo(z₁)Ti(z₂)O₂ (x+z₁+z₂=1, 0<z₁≦x, and 0<z₂≦0.1304), in which Me₁ to Meₙ each represent an element that can take a rutile-type structure or a MoO₂-type structure as an oxide.

This application claims priority of Japanese Patent Application Nos. 2013-247167 and 2013-247168, filed on Nov. 29, 2013, contents of which are hereby incorporated by reference.

### BACKGROUND

1. Technical Field

The present disclosure relates to an active material of a lithium ion secondary battery and a lithium ion secondary battery using the active material.

2. Description of Related Art

Lithium ion secondary batteries have high voltage and high energy density and are thus expected to serve as high-performance power sources of electronic appliances, power storages, and electric vehicles.

A lithium ion secondary battery typically includes a positive electrode, a negative electrode, a separator disposed between the positive electrode and the negative electrode, and an electrolyte. A polyolefin microporous film is used as the separator, for example. A nonaqueous electrolyte such as liquid lithium prepared by dissolving a lithium salt, such as LiBF₄ or LiPF₆, in an aprotic organic solvent is used as the electrolyte, for example. The positive electrode contains a positive electrode active material such as lithium cobalt oxide (e.g., LiCoO₂), for example. The negative electrode contains a negative electrode active material that uses any of various carbon materials such as graphite, for example.

A lithium ion secondary battery that uses a carbon material as a negative electrode active material sometimes has lithium metal precipitating on the negative electrode surface. This is because the oxidation-reduction potential of the carbon material is close to the precipitation potential of lithium metal and high-rate charging and slight charging nonuniformity within the electrode may result in the precipitation. Precipitation of lithium metal is one of the issues that development of lithium ion secondary batteries faces since precipitation of lithium metal may cause degradation of cycle life (especially when the battery is used at low temperature).

Negative electrode active materials that undergo oxidation and reduction at a potential sufficiently higher than the lithium metal precipitation potential have been proposed. Examples of these materials are MoO₂ (refer to Japanese Unexamined Patent Application Publication No. 2008-198593) which has an oxidation-reduction potential of 1.2 V with respect to lithium metal and WO₂ (refer to the description of U.S. Pat. No. 6,291,100) which has an oxidation-reduction potential of 0.5 V.

### SUMMARY

A lithium ion secondary battery that uses WO₂ as an active material undergoes significant voltage changes during charging and discharging, which has been a problem. To be more specific, in charge-discharge curves indicating the relationship between voltage and the lithium ion charge ratio of the active material or capacitance per gram of active material, a rapid change in voltage is known to occur between two regions called plateaus where voltage change is relatively gentle. Due to this phenomenon, voltage controllability has been low and the flexibility of battery design has been limited. Thus, there is a possibility that the ranges of capacitance and voltage that can be actually used in batteries would be limited.

A non-limiting exemplary embodiment of the present application provides an active material that suppresses the rapid voltage changes described above and offers good oxidation-reduction potential controllability, and a lithium ion secondary battery that uses the active material and exhibits good voltage controllability.

An active material of a lithium ion secondary battery according to one embodiment of the present disclosure that addresses the above-described issues includes a composition represented by W(x)Me₁(z₁)Me₂(z₂) . . . Meₙ(zₙ)O₂ (where x+z₁+z₂+ . . . +zₙ=1, n is an integer of 1 or more, and 0<max{z₁, z₂, . . . , zₙ}/x<1/2) in which Me₁ to Meₙ each represent an element that can take a rutile-type structure or a MoO₂-type structure as an oxide.

General and specific embodiments of the disclosure may be realized through batteries, apparatuses, systems, or methods, or any combination of a material, a battery, an apparatus, a system, and a method.

According to embodiments of the present disclosure, a lithium ion secondary battery active material having good oxidation-reduction potential controllability and a lithium ion secondary battery using the active material and having good voltage controllability can be provided.

Additional benefits and advantages of the disclosed embodiments will be apparent from the specification and Figures. The benefits and/or advantages may be individually provided by the various embodiments and features of the specification and Figures, and need not all be provided in order to obtain one or more of the same

### BRIEF DESCRIPTION OF THE DRAWINGS

FIG. 1 is a cross-sectional view illustrating a lithium ion secondary battery according to a first embodiment of the present disclosure;

FIG. 2A is a graph indicating charge curves of lithium ion secondary batteries that respectively use an active material A7 (W(x)Mo(y)O₂, x:y=8:1) of Example and an active material C1 (WO₂) and an active material C2 (MoO₂) of Comparative Examples and FIG. 2B is a graph indicating differential curves (absolute values of differential values) of the charge curves;

FIG. 3A is a graph indicating charge curves of lithium ion secondary batteries that respectively use an active material B4 (W(x)Ti(z)O₂, x:z=4:1) of Example and the active material C1 (WO₂) and the active material C2 (MoO₂) of Comparative Examples and FIG. 3B is a graph indicating differential curves (absolute values of differential values) of the charge curves;

FIG. 4A is a graph indicating discharge curves of lithium ion secondary batteries that respectively use the active material A7 of Example and the active material C1 (WO₂) and the active material C2 (MoO₂) of Comparative Examples and FIG. 4B is a graph indicating discharge curves of lithium ion secondary batteries that respectively use the active material B4 of Example and the active material C1 (WO₂) and the active material C2 (MoO₂) of Comparative Examples;

FIG. 5 is a graph indicating a relationship between a mixing ratio R of W to Mo (W:Mo=R:1) in each active material and the maximum value of a peak α in the differential curve;

FIG. 6 is a ternary graph indicating compositions of active materials and results of potential controllability evaluation of cells that use the active materials;

FIGS. 7A and 7B are graphs schematically indicating charge curves of an active material (MoO₂) of related art and an active material A of a first embodiment, respectively;

FIG. 8 is a cross-sectional view illustrating a lithium ion secondary battery according to a second embodiment of the present disclosure;

FIG. 9 is a ternary graph indicating a compositional range of the active material of the second embodiment;

FIG. 10A is a graph indicating charge curves of lithium ion secondary batteries that respectively use an active material D8 (W(x)Mo(y)Ti(z)O₂, x:y:z=9:1:1) of Example and the active material C1 (WO₂) and the active material C2 (MoO₂) of Comparative Examples and FIG. 10B is a graph indicating differential curves (absolute values of differential values) of the charge curves;

FIG. 11 is a graph indicating a relationship between a mixing ratio R (W:Mo:Ti=9:R:1−R) in each active material and the maximum value of a peak β in the differential curve;

FIG. 12 is a ternary graph indicating compositions of active materials and results of potential controllability evaluation of cells that use the active materials;

FIG. 13 is a ternary graph indicating desirable ranges of the compositions of the active materials and results of potential controllability evaluation of cells that use the active materials;

FIG. 14 is a graph indicating discharge curves of lithium ion secondary batteries that use an active material D8 (W(x)Mo(y)Ti(z)O₂, x:y:z=9:1:1) of Example and the active material C1 (WO₂) and the active material C2 (MoO₂) of Comparative Examples;

FIGS. 15A and 15B are graphs schematically indicating charge curves of an active material (MoO₂) of related art and an active material A of a second embodiment, respectively; and

FIG. 16A is a schematic view of a crystal structure of WO₂ and FIG. 16B is a schematic view of a crystal structure of a rutile-type TiO₂.

### DETAILED DESCRIPTION

An active material of a lithium ion secondary battery according to one embodiment of the present disclosure has a composition represented by the following formula: W(x)Me₁(z₁)Me₂(z₂) . . . Meₙ(zₙ)O₂ (where x+z₁+z₂+ . . . +zₙ=1, n is an integer of 1 or more, and 0<max{z₁, z₂, . . . , zₙ}/x<1/2.)

Me₁ to Meₙ each represent an element that can take a rutile-type structure or a MoO₂-type structure as an oxide.

Me₁ to Meₙ may be n elements selected from the group consisting of Ti, V, Cr, Ge, Mn, Nb, Mo, Ru, Rh, Sn, Te, Ta, Re, Os, Ir, Pt, and Pb.

The composition of the active material may be represented by W(x)Ti(z₁)O₂ (where 0<z₁/x≦1/3).

The composition of the active material may satisfy 1/7≦z₁/x.

The composition of the active material may be represented by W(x)Mo(z₁)O₂.

The composition of the active material may satisfy z₁/x≦1/8.

An active material according to another embodiment has a composition represented by W(x)Mo(z₁)Ti(z₂)O₂ (where x+z₁+z₂=1, 0<z₁≦x and 0<z₂≦0.1304).

The composition of the active material may satisfy z₂/z₁≦1.

A lithium ion secondary battery according to an embodiment of the disclosure includes a positive electrode that includes a positive electrode active material that can intercalate and deintercalate lithium ions, a negative electrode that includes the aforementioned active material, and an electrolyte having a lithium ion conductivity and being disposed between the positive electrode and the negative electrode.

Embodiments of active materials according to the present disclosure will now be described. The active materials according to embodiments can intercalate and deintercalate lithium ions and can be used as, for example, negative electrode active materials of lithium ion secondary batteries.

Findings that LED to the Present Disclosure

The inventors attempted to suppress rapid changes in voltage during charging and discharging of a lithium ion secondary battery that uses MoO₂ or WO₂ as an active material. Firstly, the inventors investigated the crystal structure of the active material before and after the rapid voltage change during charging by using the battery through X-ray diffraction. The results have found that the active material is monoclinic before the rapid change (in other words, on the low lithium charge ratio side of the change point) whereas the active material is orthorhombic after the rapid change (in other words, on the high lithium charge ratio side of the change point). That is, it has been found that due to intercalation of lithium ions, MoO₂ or WO₂ undergoes structural transition from monoclinic to orthorhombic. It is presumed that the rapid change in energy caused by this structural transition appears as a rapid change in voltage.

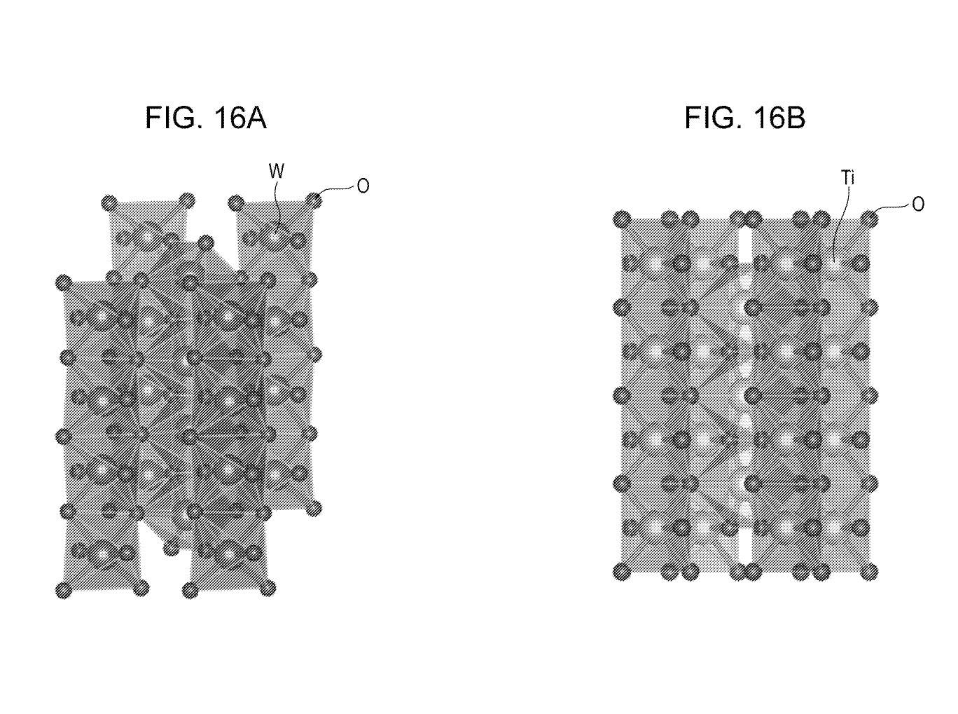

Referring to FIG. 16A, the crystal structure of WO₂ is known to have WO₆ octahedrons sharing ridges with one another in only one direction (the vertical direction in FIG. 16A), thereby forming a one-dimensional chain of octahedrons. A representative example of a structure that has this one-dimensional chain is TiO₂ having a rutile structure illustrated in FIG. 16B. Thus this one-dimensional chain is called a rutile chain.

Although WO₂ and TiO₂ have similar rutile chains, WO₂ is monoclinic and TiO₂ is orthorhombic. This is due to the way atoms in the rutile chain are aligned. In WO₂, the intervals between W atoms in the rutile chain are a repetition of long and short intervals and the order in which the long and short intervals appear is shifted between adjacent rutile chains, thereby giving a monoclinic crystal structure. MoO₂ has the same monoclinic structure. In contrast, in TiO₂, the intervals between Ti atoms in the rutile chain are constant and no shift occurs between adjacent rutile chains, thereby giving an orthorhombic crystal structure.

Based on this knowledge, the inventors have assumed the cause of the structural transition of MoO₂ and WO₂ from monoclinic to orthorhombic associated with lithium ion intercalation. The inventors have assumed that this structural transition is caused by a change in the way in which atoms in the rutile chains are aligned. The inventors thought that preventing the change in the way would suppress rapid changes in voltage. Thus, the inventors have come up with an idea that the structural transition associated with lithium ion intercalation may be inhibited by substituting the Mo and W atoms in the rutile chain with other atoms so as to disturb the way in which the long and short atomic intervals are repeated in the rutile chain.

In order to maintain the chain structure without causing breaking of the rutile chain despite the atom substitution, the elements used for substitution are selected from Ti, V, Cr, Ge, Mn, Nb, Mo, Ru, Rh, Sn, Te, Ta, Re, Os, Ir, Pt, and Pb. These elements can form an oxide having a rutile chain. That is, these elements can form a rutile-type structure (FIG. 16B) or a MoO₂-type structure (FIG. 16A) as an oxide. The inventors have adjusted the ratio of these elements used for substitution. Thereby, the inventors have succeeded in suppressing the structural transition associated with lithium ion intercalation and suppressing rapid changes in voltage.

The active material of the lithium ion battery according to an embodiment has a composition represented by the following formula: W(x)Me₁(z₁)Me₂(z₂) . . . Meₙ(zₙ)O₂ (where x+z₁+z₂+ . . . +zₙ=1, n is an integer of 1 or more, 0<max{z₁, z₂ . . . zₙ}/x<1/2). Me₁ to Meₙ each represent an element that can take a rutile-type structure or a MoO₂-type structure as an oxide and max is an operator symbol for determination of the maximum value.

### First Embodiment

An active material according to a first embodiment has a composition represented by W(x)Ti(z)O₂ (where x+z=1 and 0<z/x<1/2) (hereinafter this composition is referred to as “active material A”) or W(x)Mo(y)O₂ (where x+y=1 and 0<y/x<1/2) (hereinafter this composition is referred to as “active material B”). The formula representing the composition of the active material is particularly desirably W(x)Ti(z)O₂ (where x+z=1 and 0<z/x≦1/3) or w(x)Mo(y)O₂ (where x+y=1 and 0<y/x≦1/3).

An active material having the aforementioned composition suppresses rapid changes in oxidation-reduction potential (hereinafter simply referred to as the “potential”) with respect to lithium metal during charging and discharging and good potential controllability is achieved. Thus, a lithium secondary battery having good voltage controllability can be realized by using the active material of this embodiment.

Since the active material has the aforementioned composition, the potential is higher than 0 V but not higher than 1.0 V. Since the potential is higher than 0 V, precipitation of lithium metal can be suppressed. Since the potential is not higher than 1.0 V, the voltage between the positive electrode and the negative electrode can be retained and the decrease in energy density can be suppressed by using the active material of this embodiment as the negative electrode material of a lithium ion secondary battery. Accordingly, a lithium secondary battery that can suppress precipitation of lithium metal and exhibits high energy density can be realized by using the active material of this embodiment.

One or more other active materials may be used in addition to the active material having the composition described above. For example, a mixture of the active material described above and one or more other active materials may be used.

The charge properties of active materials of related art and active materials A and B according to this embodiment will now be described with reference to the drawings.

### Active Materials of Related Art: WO₂ and MoO₂

As described above, active materials of related art, namely, WO₂ and MoO₂, have a problem of a rapid change in voltage during charging.

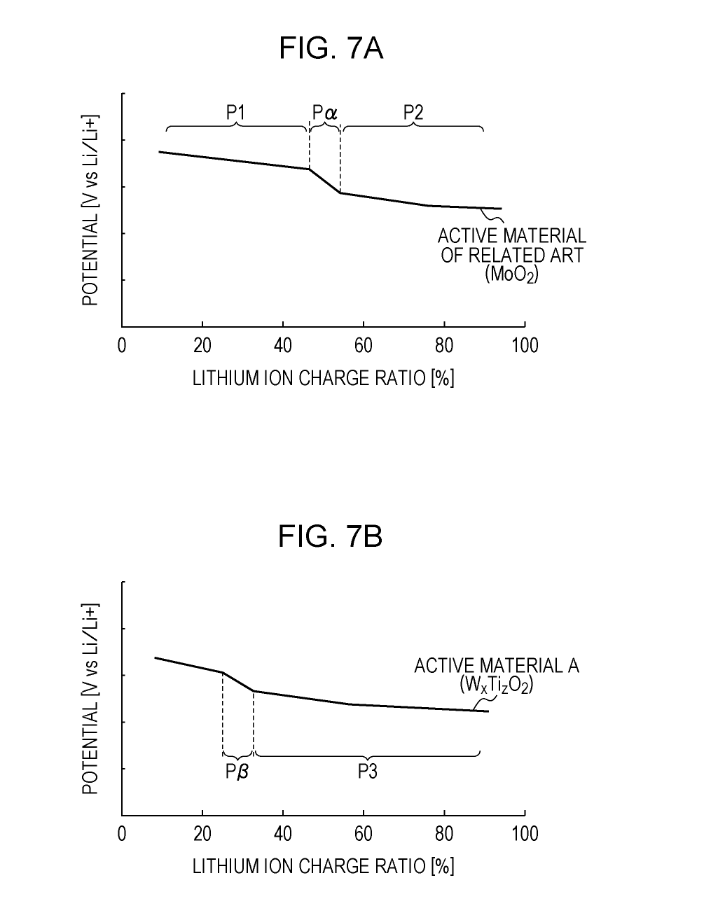

FIG. 7A schematically illustrates an example of a charge curve of an active material (MoO₂) of related art. Note that the graph of FIG. 7A is merely a model graph for illustrating the tendency of potential changes during charging and the potential value (vertical axis) is not specified.

As is schematically illustrated in FIG. 7A, the charge curve of MoO₂ includes regions (plateaus) P1 and P2 in which the potential changes relatively gently. The potential in the region P1 is higher than the potential in the region P2. A region Pα in which the potential rapidly changes is present between the regions P1 and P2. The region Pα is located at a lithium ion charge ratio of about 50%. In such a case, the range of the lithium ion charge ratio within which sufficient potential controllability is obtained is the region on the high-lithium-ion-charge-ratio side of the region Pα, in other words, the range corresponding to the region P2 where the potential change is small. Although not illustrated in the graph, the charge curve of WO₂ exhibits the same tendency.

Active Material A: W(x)Ti(z)O₂ (where x+z=1 and 0<z/x<1/2)

FIG. 7B schematically illustrates an example of a charge curve of the active material A. The region Pα where the potential rapidly changes is observed at a lithium ion charge ratio of about 50% in the charge curve of MoO₂. On the other hand, a rapid change in potential is substantially absent at a lithium ion charge ratio of about 50% in the charge curve of the active material A. The charge curve of the active material A has a region Pβ extending from a lithium ion charge ratio of about 15% to 35%, where a change in potential that is rather rapid and is different from the potential change in the region Pα occurs. This potential change is more gentle than the potential change in the region Pα. A region (plateau) P3 where the change in potential is gentle is present on the high-lithium-ion-charge-ratio side of the region Pβ. Accordingly, the range of the lithium ion charge ratio in which sufficient potential controllability is obtained with the active material A is the range corresponding to the region P3 where the potential change is small. The region P3 is on the high-lithium-ion-charge-ratio side of the region Pβ. The range of the lithium ion charge ratio of the region P3 is wider than the range of the lithium ion charge ratio of the region P2 for the active material of related art. Accordingly, good potential controllability is obtained throughout a wider range of the lithium ion charge ratio. Moreover, as described later, when the composition satisfies 1/7≦z/x≦1/3, the capacitance per gram of the active material can be further increased while maintaining a particular potential.

Active Material B: W(x)Mo(y)O₂ (where x+y=1 and 0<y/x<1/2)

Although not illustrated in the drawing, the charge curve of the active material B can have a relatively large potential change at a lithium ion charge ratio of about 50% or a lithium ion charge ratio of 15% to 35% depending on the composition (y/x) of the active material B. However, as with the active material A, the change in potential at a lithium ion charge ratio of about 50% is smaller than that of the active material of related art. Accordingly, the potential at a lithium ion charge ratio of about 50% can be easily controlled and good potential controllability can be achieved throughout a wider range of lithium ion charge ratios including a lithium ion charge ratio of 50%. Moreover, as described later, when the composition satisfies 0<y/x≦1/8, the change in potential at a lithium ion charge ratio of about 50% is substantially absent and thus the potential controllability can be further enhanced.

### Method for Manufacturing Active Material

An example of a method for manufacturing the active material according to this embodiment will now be described.

For example, tungsten dioxide (WO₂) is used as a tungsten (W) material used to make the active material of this embodiment. Molybdenum dioxide (MoO₂) is used as the molybdenum (Mo) material, for example. Titanium dioxide (TiO₂) having a rutile or anatase structure is used as a titanium (Ti) material.

The active material of this embodiment is W(x)Ti(z)O₂ (where x+z=1 and 0<z/x<1/2) or W(x)Mo(y)O₂ (where x+y=1 and 0<y/x<1/2). This active material is, for example, obtained by pulverizing and mixing the raw materials described above and firing the resulting mixture in a reducing atmosphere. The firing temperature is set to, for example, 700° C. or more and 1300° C. or less and desirably 1100° C. or more and 1200° C. or less. At an excessively low firing temperature, the reactivity is degraded and a longer firing time is necessary to obtain a single phase. At an excessively high firing temperature, the production cost is increased and the crystallinity may be lost due to fusing.

The method for manufacturing the active material is not limited to the method described above. Any of various synthetic methods, such as hydrothermal synthesis, supercritical synthesis, and a co-precipitation process, may be employed instead of the aforementioned method.

### Structure of Lithium Ion Secondary Battery

Next, a structure of a lithium ion secondary battery that uses the active material of this embodiment is described. In this embodiment, it is sufficient if one of the electrodes of the lithium ion secondary battery contains the active material described above and the rest of the structure is not particularly limited.

A lithium ion secondary battery that uses the active material of this embodiment includes a negative electrode that contains the active material of this embodiment as the negative electrode active material, a positive electrode that contains an active material (positive electrode active material) that can intercalate and deintercalate lithium ions, a separator disposed between the positive electrode and the negative electrode, and an electrolyte having lithium ion conductivity.

The negative electrode includes a negative electrode current collector and a negative electrode mix supported on the negative electrode current collector. The negative electrode mix contains the active material of this embodiment, that is, W(x)Ti(z)O₂ (where x+z=1 and 0<z/x<1/2) or W(x)Mo(y)O₂ (where x+y=1 and 0<y/x<1/2). The negative electrode mix may further contain one or more other active materials, a binder, a conductive agent, and the like. The negative electrode can be prepared by, for example, mixing a negative electrode mix with a liquid component to prepare a negative electrode mix slurry, applying the slurry to a negative electrode current collector, and drying the applied slurry.

The blend ratios of the binder and the conductive agent relative to 100 parts by weight of the active material (negative electrode active material) of the negative electrode are desirably in the range of 1 part by weight or more and 20 parts by weight or less for the binder and 1 part by weight or more and 25 parts by weight or less for the conductive agent.

For example, stainless steel, nickel, copper, or the like is used as the negative electrode current collector. The thickness of the negative electrode current collector is not particularly limited and is desirably 1 to 100 μm and more desirably 5 to 20 μm. When the thickness of the negative electrode current collector is within the above-described range, weight reduction can be achieved while maintaining the strength of the electrode plate.

The positive electrode includes a positive electrode current collector and a positive electrode mix supported on the positive electrode current collector. The positive electrode mix may contain a positive electrode active material, a binder, a conductive agent, and the like. The positive electrode can be prepared by mixing the positive electrode mix with a liquid component to prepare a positive electrode mix slurry, applying the slurry to a positive electrode current collector, and drying the applied slurry.

Examples of the positive electrode material include complex oxides such as lithium cobaltate and modified lithium cobaltate (such as eutectics with aluminum or magnesium), lithium nickelate and modified lithium nickelate (such as lithium nickelate with nickel partly substituted with cobalt or manganese), and lithium manganate and modified lithium manganate; lithium iron phosphate and modified lithium iron phosphate; and lithium manganese phosphate and modified lithium manganese phosphate. These positive electrode active materials can be used alone or in combination.

Examples of the binder for the positive or negative electrode include PVDF, polytetrafluoroethylene, polyethylene, polypropylene, aramid resin, polyamide, polyimide, polyamideimide, polyacrylonitrile, polyacrylic acid, methyl ester of polyacrylic acid, ethyl ester of polyacrylic acid, hexyl ester of polyacrylic acid, polymethacrylic acid, methyl ester of polymethacrylic acid, ethyl ester of polymethacrylic acid, hexyl ester of polymethacrylic acid, polyvinyl acetate, polyvinylpyrrolidone, polyether, polyether sulfone, hexafluoropolypropylene, styrene butadiene rubber, and carboxymethyl cellulose. A copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can also be used. A mixture of two or more selected from the aforementioned group can also be used. Examples of the conductive agent to be contained in the electrode include graphite materials such as natural graphite and artificial graphite, carbon blacks such as acetylene black, Ketjen black, channel black, furnace black, lamp black, and thermal black, conductive fibers such as carbon fibers and metal fibers, metal powders such as carbon fluoride and aluminum, conductive whiskers such as zinc oxide and potassium titanate, conductive metal oxides such as titanium oxide, and organic conductive materials such as phenylene derivatives.

The blend ratios of the binder and the conductive agent relative to 100 parts by weight of the positive electrode active material are 1 part by weight or more and 20 parts by weight or less for the binder and 1 part by weight or more and 25 parts by weight or less for the conductive agent.

For example, stainless steel, aluminum, titanium, or the like is used as the positive electrode current collector. The thickness of the positive electrode current collector is not particularly limited and is desirably 1 to 100 μm and more desirably 5 to 20 μm. When the thickness of the positive electrode current collector is within the above-described range, weight reduction can be achieved while maintaining the strength of the electrode plate.

The separator disposed between the positive electrode and the negative electrode is, for example, a microporous thin film, a woven cloth, a nonwoven cloth, or the like that has sufficient permeability to ions and particular mechanical strength and insulating properties. A microporous thin film may be a film composed of one material or a composite film or multilayered film composed of two or more materials. The material for the separator may be a polyolefin such as polypropylene or polyethylene. Since polyolefin has high durability and a shut-down function, the reliability and safety of the lithium ion secondary battery can be further enhanced by using a polyolefin. The thickness of the separator is, for example, 10 to 300 μm, desirably 10 to 40 μm, and more desirably 10 to 25 μm. The porosity of the separator is desirably in the range of 30% to 70% and more desirably in the range of 35% to 60%. The “porosity” refers to the volume ratio of pores (or voids) relative to the entire separator.

A liquid, gel, or solid substance can be used as the electrolyte.

A liquid nonaqueous electrolyte (nonaqueous electrolyte solution) is obtained by dissolving an electrolyte (for example, a lithium salt) in a nonaqueous solvent. A gel nonaqueous electrolyte contains a nonaqueous electrolyte and a polymer material that supports the nonaqueous electrolyte. Examples of the polymer material include polyvinylidene fluoride, polyacrylonitrile, polyethylene oxide, polyvinyl chloride, polyacrylate, and polyvinylidene fluoride hexafluoropropylene.

A known nonaqueous solvent can be used as the nonaqueous solvent in which an electrolyte is to be dissolved. The nonaqueous solvent may be of any type and may be, for example, a cyclic carbonate, a linear carbonate, or a cyclic carboxylate. Examples of the cyclic carbonate include propylene carbonate (PC) and ethylene carbonate (EC). Examples of the linear carbonate include diethyl carbonate (DEC), ethyl methyl carbonate (EMC), and dimethyl carbonate (DMC). Examples of the cyclic carboxylate include γ-butyrolactone (GBL) and γ-valerolactone (GVL). These nonaqueous solvents can be used alone or in combination.

Examples of the electrolyte to be dissolved in the nonaqueous solvent include LiClO₄, LiBF₄, LiPF₆, LiAlCl₄, LiSbF₆, LiSCN, LiCF₂SO₃, LiCF₃CO₂, LiAsF₆, LiB₁₀Cl₁₀, lower aliphatic carboxylic acid lithium, LiCl, LiBr, LiI, chloroborane lithium, borates, and imide salts. Examples of the borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium (5-fluoro-2-olate-1-benzenesulfonate-O,O′)borate. Examples of the imide salts include lithium bistrifluoromethane sulfonimide ((CF₃SO₂)₂NLi), lithium (trifluoromethanesulfonyl)(nonafluorobutanesulfonyl)imide (LiN(CF₃SO₂)(C₄F₉SO₂)), and lithium bispentafluoroethanesulfonimide ((C₂F₅SO₂)₂NLi). These electrolytes may be used alone or in combination.

The nonaqueous electrolyte solution may contain, as an additive, a material that decomposes on the negative electrode, forms a film having high lithium ion conductivity, and enhances the charge-discharge efficiency. Examples of the additive having such functions include vinylidene carbonate (VC), 4-methylvinylidene carbonate, 4,5-dimethylvinylidene carbonate, 4-ethylvinylidene carbonate, 4,5-diethylvinylidene carbonate, 4-propylvinylidene carbonate, 4,5-dipropylvinylidene carbonate, 4-phenylvinylidene carbonate, 4,5-diphenylvinylidene carbonate, vinyl ethylene carbonate (VEC), and divinyl ethylene carbonate. These may be used alone or in combination. Of these, the additive is desirably at least one selected from the group consisting of vinylidene carbonate, vinyl ethylene carbonate, and divinyl ethylene carbonate. These compounds may have some hydrogen atoms substituted with fluorine atoms. The amount of the electrolyte dissolved in the nonaqueous solvent is desirably in the range of 0.5 to 2 mol/L.

A known benzene derivative that decomposes at the time of overcharging and forms a film on the electrode to inactivate the battery may be added to the nonaqueous electrolyte. The benzene derivative may contain a phenyl group and a cyclic compound group adjacent to the phenyl group. The cyclic compound group may be a phenyl group, a cyclic ether group, a cyclic ester group, a cycloalkyl group, or a phenoxy group, for example. Specific examples of the benzene derivative include cyclohexylbenzene, biphenyl, and diphenyl ether. These may be used alone or in combination. The benzene derivative content is desirably 10% by volume or less of the entire nonaqueous solvent.

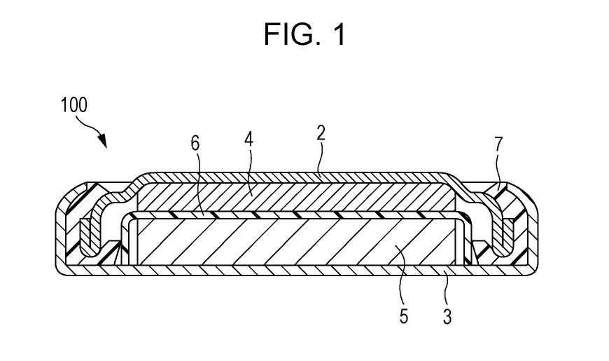

FIG. 1 is a schematic cross-sectional view illustrating an example of a lithium ion secondary battery 100 having a coin shape.

The lithium ion secondary battery 100 includes an electrode assembly that includes a negative electrode 4, a positive electrode 5, and a separator 6. The negative electrode 4 and the positive electrode 5 are arranged so that the negative electrode mix faces the positive electrode mix. The separator 6 is disposed between the negative electrode 4 and the positive electrode 5 (i.e. between the negative electrode mix and the positive electrode mix). The electrode assembly is impregnated with an electrolyte (not illustrated) having lithium ion conductivity. The positive electrode 5 is electrically connected to a battery case 3 that serves as a positive electrode terminal. The negative electrode 4 is electrically connected to a sealing plate 2 that serves as a negative electrode terminal. The opening end of the battery case 3 is clamped with a gasket 7 disposed at the periphery of the sealing plate 2 and thus the whole battery is hermetically sealed. Although the battery in FIG. 1 has a coin shape, the lithium ion secondary battery according to this embodiment is not limited to one having a coin shape and may have a button shape, a sheet shape, a cylinder shape, a flat shape, or a rectangular shape.

### Examples

Active materials of Examples were prepared and evaluated. The method and results are described below.

### (1) Preparation of Active Material

Raw material powders of WO₂, MoO₂, and TiO₂ at a molar ratio indicated in Table 1 were thoroughly mixed by using an agate mortar. The resultant mixture was fired at 1200° C. for 8 hours in a reducing atmosphere containing a hydrogen-carbon dioxide gas (1:1 on a molar basis) mixture. As a result, active materials A1 to A7 and B1 to B7 were obtained.

The active materials A1 to A7 are each a metal oxide that contains W and Ti but substantially no Mo. Of these, the active materials A3 to A7 are active materials of Examples having compositions represented by W(x)Ti(z)O₂ (x+z=1 and 0<z/x<1/2). The active materials A1 and A2 are active materials of Comparative Examples in which z/x is ½ or more.

The active materials B1 to B7 are each a metal oxide that contains W and Mo but substantially no Ti. Among these, the active materials B3 to B7 are active materials of Examples having compositions represented by W(x)Mo(y)O₂ (x+y=1 and 0<y/x<1/2). The active materials B1 and B2 are active materials of Comparative Examples in which y/x is ½ or more.

For comparison, an active material C1 that contained only WO₂ and an active material C2 that contained only MoO₂ were prepared by the same method as above.

Each of the active materials of Examples and Comparative Examples were analyzed through X-ray diffractometry (XRD). The results found that in all active materials, WO₂, MoO₂, and TiO₂ formed a solid solution without undergoing phase separation and formed a single phase free of by-products. Accordingly, the molar ratios of the raw materials directly correspond to the composition ratios in each active material. The composition of each active material is indicated in Table 1.

Table 1 indicates that the peak-suppressing effect is stronger with Ti-substituted materials (cells A) than with Mo-substituted materials (cells B). Accordingly, the atoms used for substitution may be Mo atoms but desirably atoms other than Mo atoms. This is presumably because Mo has an ionic radius and other properties relatively close to those of W and thus an active material in which W is substituted with Mo tends to behave like WO₂ and the effect of disturbing the regularity of the atomic intervals in the rutile chain is weak.

TABLE 1

| | Mixing molar | | | | | | | | | |
|---|---|---|---|---|---|---|---|---|---|---|
| | ratio of active | | | Composition of | | | | | | |
| | material | | | active material | | | Peak α | | Peak β | |
| Evaluation | W | Mo | Ti | W | Mo | Ti | Position | Maximum | Position | Maximum |
| cell | (x) | (y) | (z) | (x) | (y) | (z) | [%] | value | [%] | value |
| A1 | 1 | 0 | 1 | 0.500 | 0.000 | 0.500 | | | | |
| A2 | 2 | | 1 | 0.667 | | 0.333 | | | | |
| A3 | 3 | | 1 | 0.750 | | 0.250 | None | None | 26.9 | 0.026 |
| A4 | 4 | | 1 | 0.800 | | 0.200 | None | None | 28.3 | 0.028 |
| A5 | 5 | | 1 | 0.833 | | 0.167 | None | None | 26.5 | 0.027 |
| A6 | 7 | | 1 | 0.875 | | 0.125 | None | None | 33.3 | 0.022 |
| A7 | 8 | | 1 | 0.889 | | 0.111 | None | None | 26.5 | 0.024 |
| B1 | 1 | 1 | 0 | 0.500 | 0.500 | 0.000 | 48.4 | 0.030 | None | None |
| B2 | 2 | 1 | | 0.667 | 0.333 | | 43.7 | 0.018 | None | None |
| B3 | 3 | 1 | | 0.750 | 0.250 | | 43.0 | 0.013 | None | None |
| B4 | 4 | 1 | | 0.800 | 0.200 | | 45.8 | 0.010 | 21.8 | 0.009 |
| B5 | 5 | 1 | | 0.833 | 0.167 | | 52.6 | 0.007 | 24.7 | 0.010 |
| B6 | 6 | 1 | | 0.857 | 0.143 | | 37.1 | 0.006 | 16.2 | 0.021 |
| B7 | 8 | 1 | | 0.889 | 0.111 | | None | None | 17.1 | 0.023 |
| C1 | 1 | 0 | 0 | 1.000 | 0.000 | 0.000 | 49.9 | 0.033 | None | None |
| C2 | 0 | 1 | 0 | 0.000 | 1.000 | 0.000 | 48.4 | 0.034 | None | None |

| | Value of | Value of | Value of | Value of | | |
|---|---|---|---|---|---|---|
| | differential | differential | differential | differential | | |
| | curve at | curve at | curve at | curve at | | Potential II |
| | charge ratio | charge ratio | charge ratio | charge ratio | | (at charge |
| Evaluation | above 35%: | above 35%: | above 25%: | above 25%: | Potential I | ratio of 35%) |
| cell | Less than 0.03 | Less than 0.015 | Less than 0.03 | Less than 0.02 | [V] | [V] |
| A1 | | | | | Charge | Charge |
| | | | | | failure | failure |
| A2 | | | | | Charge | Charge |
| | | | | | failure | failure |
| A3 | YES | YES | YES | NO | 0.95 | 0.77 |
| A4 | YES | YES | YES | NO | 0.95 | 0.78 |
| A5 | YES | YES | YES | NO | 0.95 | 0.76 |
| A6 | YES | YES | YES | NO | 0.93 | 0.80 |
| A7 | YES | YES | YES | NO | 0.94 | 0.72 |
| B1 | NO | NO | NO | NO | 0.97 | 0.96 |
| B2 | YES | NO | YES | YES | 0.91 | 0.81 |
| B3 | YES | YES | YES | YES | 0.88 | 0.77 |
| B4 | YES | YES | YES | YES | 0.87 | 0.76 |
| B5 | YES | YES | YES | YES | 0.97 | 0.76 |
| B6 | YES | YES | YES | YES | 0.89 | 0.67 |
| B7 | YES | YES | YES | YES | 0.88 | 0.65 |
| C1 | NO | NO | NO | NO | 1.12 | 0.82 |
| C2 | NO | NO | NO | NO | 1.80 | 1.58 |

### (2) Preparation of Electrodes

Electrodes were made by using the active materials obtained by the methods described above. Specifically, 100 parts by weight of the active material, 10 parts by weight of acetylene black serving as a conductive agent, 10 parts by weight of polyvinylidene fluoride serving as a binder, and an appropriate amount of of N-methyl-2-pyrrolidone (NMP) solution serving as a dispersion medium were mixed to prepare a mix paste.

The mix paste was applied to a surface of a current collector and dried to form an active material layer. A copper foil having a thickness of 18 μm was used as the current collector. Then the current collector with the active material layer formed thereon was subjected to flat-plate pressing at 2 ton/cm² and compressed until the total thickness of the current collector and the active material layer was reduced to 100 μm. A round piece having a diameter of 12.5 mm was punched out from the current collector with the active material layer thereon to form an electrode.

### (3) Preparation of Counter Electrode

A round piece having a diameter of 14.5 mm was punched out from a Li foil having a thickness of 300 μm to form a counter electrode.

### (4) Preparation of Nonaqueous Electrolyte

In a mixed solvent containing ethylene carbonate and ethyl methyl carbonate at a volume ratio of 1:3, LiPF₆ serving as a solute was dissolved to a concentration of 1.0 mol/L so as to obtain a nonaqueous electrolyte.

### (5) Preparation of Evaluation Cells

A cell for evaluation was prepared by using the electrode described above as a working electrode and the Li foil as the counter electrode.

Each evaluation cell had a structure illustrated in FIG. 1. The battery case 3 and the sealing plate 2 were made by processing a stainless steel plate having resistance to organic electrolyte solutions. The negative electrode 4 (serves as a working electrode 4) was one of the electrodes described above and the positive electrode 5 (namely, the counter electrode 5) was the Li foil described above. In each evaluation cell, a part of the battery case 3 functioned as a current collector. A microporous polypropylene separator was used as the separator 6 and a polypropylene resin insulating gasket was used as the gasket 7.

In Examples, the Li foil was spot-welded onto an inner surface of the battery case 3 to obtain a counter electrode 5. A separator 6 was then placed on the counter electrode 5 and a nonaqueous electrolyte was placed in the separator 6. The electrode described above serving as the working electrode 4 was press-bonded onto the inner side of the sealing plate 2. The sealing plate 2 with the working electrode 4 press-bonded thereon was fitted into the opening of the battery case 3 with the gasket 7 therebetween and the opening was sealed. As a result, an evaluation cell having a coin shape was obtained.

In this specification, an evaluation cell that uses, as the working electrode 4, an electrode prepared by using the active material A1 in Table 1 is named “cell A1”. Similarly, evaluation cells that use, as working electrodes 4, electrodes prepared by using the active materials A2 to A7, B1 to B7, C1, and C2 are also named according to the reference numbers of the active materials.

### (6) Evaluation of Charge-Discharge Properties

The evaluation cells were subjected to charge-discharge cycle testing to measure the charge-discharge properties. To be specific, the cycle that included charging the cell in a room temperature environment at a constant current of 0.1 mA until a voltage of 0.5 V was reached and then discharging the cell at a constant current of 0.1 mA until a voltage of 1.5 V was reached to deintercalate the lithium ions from the active material was repeated. However, because the cell C2 that used the active material C2 containing only MoO₂ constantly had a potential higher than 0.5 V, charging was conducted until the lithium ion charge ratio was about 90% and discharging was conducted until 2.5 V was reached.

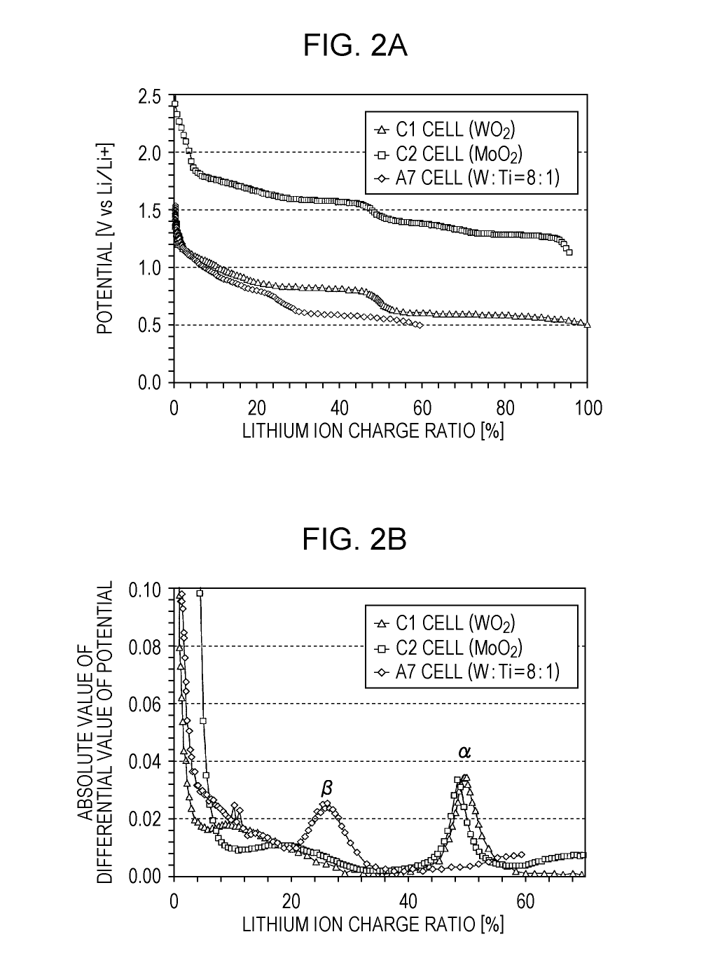

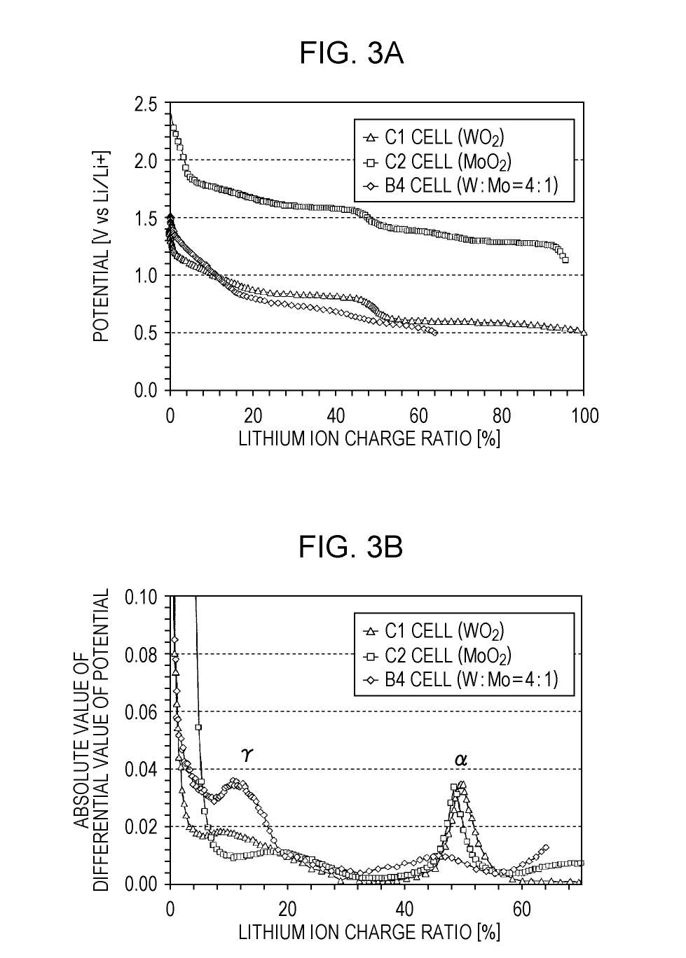

The measurement results of the charge-discharge properties will now be described with reference to FIGS. 2A to 3B.

FIGS. 2A and 2B are graphs respectively indicating a charge curve and a differential curve of the charge curve of the cell A7 that uses the active material A7 indicated in Table 1, and being taken on the second cycle of the testing. FIGS. 3A and 3B are graphs respectively indicating a charge curve and a differential curve of the charge curve of the cell B4 that uses the active material B4 indicated in Table 1, and being taken on the second cycle of testing. For comparison, the charge curves and differential curves of the cells C1 and C2 that use the active material C1 (WO₂) and the active material C2 (MoO₂) of Comparative Examples are also indicated in these graphs.

In FIGS. 2A and 3A, the charge curve was plotted on the horizontal axis indicating the lithium ion charge ratio for the active material and the vertical axis indicating the potential (potential with respect to lithium metal) of the electrode (working electrode 4). The lithium ion charge ratio was determined from the time integration of the current based on the assumption that the current flowing in the cell was completely involved in lithium ion intercalation and deintercalation for the active material, and is indicated as a percentage value where 100% corresponds to the compositional ratio, Li(1)W(x)Mo(y)Ti(z)O₂ (x+y+z=1).

In FIGS. 2B and 3B, the differential curves are plotted on the horizontal axis indicating the lithium ion charge ratio and the vertical axis indicating the absolute value of the differential value of the potential with respect to the lithium ion charge ratio. Each differential curve was obtained by dividing the difference in potential between two adjacent measurement points on a charge curve with a difference in lithium ion charge ratio and plotting the absolute values of the results. The intervals along the horizontal axis (lithium ion charge ratio) between adjacent measurement points in the differential curve were set to 0.28% or more and 1.6% or less.

The inflection points of the charge curves in FIGS. 2A and 3A appear as peaks in the differential curves in FIGS. 2B and 3B. The larger the maximum value of the peak and the smaller the half width, the more rapid the change in potential between before and after the inflection point. The value along the vertical axis of the differential curve (the absolute value of the differential value, hereinafter simply referred to as the “value of the differential curve”) indicates the slope of the potential at that charge ratio. This means that the smaller the value of the differential curve, the more gentle the change in potential. The intervals along the horizontal axis (lithium ion charge ratio) between adjacent two measurement points on the differential curve are not particularly limited. For example, when the intervals are 2% or less (larger than 0% but not larger than 2%), the position and maximum value of the peak and the shape of the peak can be more reliably investigated.

FIG. 2A indicates that the charge curves of the cells C1 and C2 of Comparative Examples have the potential rapidly changing at about a lithium ion charge ratio of about 50%. This change appears as peaks α in the differential curves of FIG. 2B. In contrast, the charge curve of the cell A7 of Example has a relatively gentle change in potential at a lithium ion charge ratio of about 50% but has a relatively large change in potential at a lithium ion charge ratio of about 25%. This change appears as a peak β in the differential curve of FIG. 2B. As understood from FIG. 2B, the peak β of the cell A7 is smaller than the peaks α of the cells C1 and C2 and is broad. The peak is “smaller” when the maximum value of the peak in the differential curve is smaller. It can be confirmed from these results that the cell A7 undergoes a relatively large change in potential in a region where the lithium ion charge ratio is low compared to the cells C1 and C2. A region (plateau) with a relatively gentle change in potential lies on the high-lithium-ion-charge-ratio side of the region where the potential change occurs. Accordingly, the cell A7 can achieve good controllability of the negative electrode potential or the battery voltage throughout a lithium ion charge ratio range wider than those for the cells C1 and C2.

FIG. 3A indicates that the charge curve of the cell B4 of Example has a relatively gentle change in potential at a lithium ion charge ratio of about 50% but has the potential rapidly changing at a lithium ion charge ratio of about 10%. This change appears as a peak γ in the differential curve of FIG. 3B. The differential curve of the cell B4 indicated in FIG. 3B also has a peak (peak α) at a lithium ion charge ratio of about 50% in addition to the peak γ. Although it is difficult to identify from the graph, a small peak (peak β) is present at a lithium ion charge ratio of about 20%. The peak α of the cell B4 is significantly smaller than the peaks α of the cells C1 and C2 and is broad. Accordingly, in the cell B4, the change in potential is relatively gentle in a region on the high-lithium-ion-charge-ratio side of the region where the peak γ is present. Thus, the cell B4 can achieve good controllability of negative electrode potential or the battery voltage throughout a lithium ion charge ratio range wider than those for the cells C1 and C2.

In FIGS. 2A and 3A, the charge curves of the cell A7 and the cell B4 are shorter than the charge curves of the cells C1 and C2. This is because the end-of-charge potential (this equals to the potential of the electrode with respect to lithium metal in this example) was set to 0.5 V in measuring the charge-discharge properties. The charge curves of the cell A7 and the cell B4 have a large change in potential immediately before the potential reaches 0.5 V. This is due to the operation of ending the charging (cut-off operation).

At least one peak was observed in each of the differential curves of the cells A3 to A7, B1 to B7, C1 and C2. These peaks were studied and were categorized into three peaks, namely, peaks α, peaks β, and peaks γ, according to the position (lithium ion charge ratio) of the peak and the peak shape:
Peak α: A peak α can appear in the lithium ion charge ratio range of about 35% to 60%. For the cell C1 (active material: WO₂) and the cell C2 (active material: MoO₂) of Comparative Examples, the peak α is sharp with a maximum value exceeding 0.03, which indicates that a significantly rapid change in potential is occurring (refer to FIGS. 2B and 3B). In contrast, for the cells A3 to A7 and B7 of Examples, the peak α is practically absent. For the cells B2 to B6, the peak α is present but the maximum value is clearly smaller than those for the cells C1 and C2 and the peak is broad.
Peak β: A peak β can appear in the lithium ion charge ratio range of about 15% to 35%. This peak does not appear for the cells C1 and C2 of Comparative Examples and appears only in the differential curves of the cells A3 to A7 that contain the active material A. Among the cells B1 to B7, the cells B4 to B7 having a relatively high W content can have a peak β. The peak profile of the peak β is linear compared to that of the peak α and the peak γ.
Peak γ: A peak γ can appear in the lithium ion charge ratio range of about 5% to 15%. The shape of the peak γ is distorted compared to the peaks α and β.

Among these peaks, the peak γ is located in an early stage of charging and it is possible that the change in potential is caused by various side reactions resulting in appearance of the peak. Accordingly, only the peaks α and β present in the practical operation range of the lithium ion charge ratio are focused in this specification and the relationship between these peaks and the composition of the active material is investigated.

Table 1 indicates the maximum values of the peaks α and β of the respective evaluation cells and the positions (the lithium ion charge ratios at which the peaks maximize) of the peaks. The investigation was conducted on the relationship between these values and the composition of the active material and the following was found.

Cells A1 to A7 that Used Active Materials Containing W and Ti (W(x)Ti(z)O₂)

For the cells A1 and A2 that used active materials having a high Ti content, charging was either not conducted at all or ended at a lithium ion charge ratio of 20% or less (this is indicated as “Charge failure” in Table 1). In contrast, the cells A3 to A7 that used active materials having a relatively low Ti content (Ti content of 0.25 or less, in other words, the compositional ratio of W to Ti, W/Ti, was ⅓ or less) could at least be charged until the potential reached the end-of-charge potential of 0.5 V and the lithium ion charge ratio at that time was more than 50%. As illustrated in FIG. 2B, the differential curves of the cells A3 to A7 had no significant peak α but a clear peak β. The maximum value of the peak β lied within a lithium ion charge ratio range of 25% to 35%. Based on these results, it was found that the cells A3 to A7 that used active materials having a relatively low Ti content can use a wide plateau on the high-lithium-ion-charge-ratio side of the peak β. Accordingly, the potential can be stably controlled against the lithium ion charge ratio and a good potential controllability can be obtained throughout a wider lithium ion charge ratio range.

Cells B1 to B7 that Used Active Materials Containing W and Mo (W(x)Mo(y)O₂)

The peak α appeared in the differential curves of the cells B1 to B6 but not in the differential curve of the cell B7 that used the active material with the lowest Mo content.

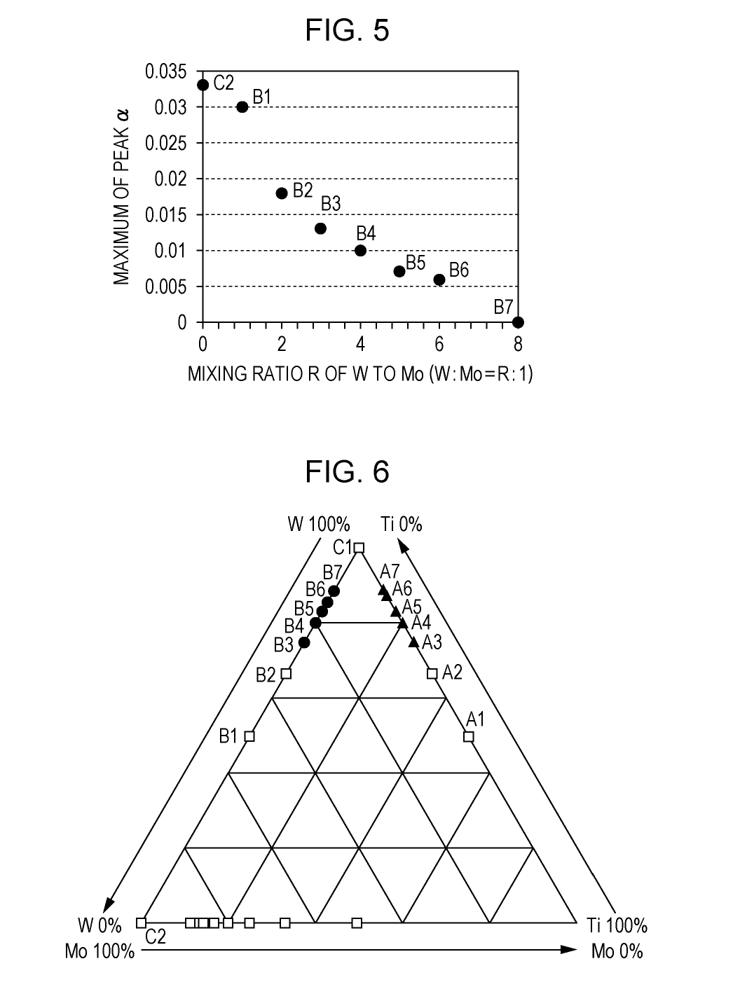

FIG. 5 is a graph indicating the relationship between the mixing ratios R (W:Mo=R:1) of the active materials used in the cells B1 to B7 and C2 and the maximum values of the peaks α. FIG. 5 indicates that the maximum value of the peak α of each cell decreases with the increase in the mixing ratio R (ratio of W to Mo) in the active material. For example, in the cell B1 with a higher W ratio R (W:Mo=1:1, R=1), the maximum value of the peak α is 0.03 and a rapid change in potential similar to that observed from the cell C2 (R=0) is present. The maximum value of the peak α sufficiently decreases with the increase in the W ratio R in the active material. In the cells B3 to B7 that use active materials having a W ratio R exceeding 2 (compositional ratio of Mo to W, Mo/W, is less than ½), either the change in potential due to the peak α is relatively gentle or no peak α is observed.

This indicates that the cells B3 to B7 of Examples can achieve good potential controllability throughout a wide lithium ion charge ratio range including the position of the peak α. In particular, for the cell B7 that uses the active material having a W ratio R of 8 or more (the compositional ratio of Mo to W is ⅛ or less), a significant peak α is substantially absent. Accordingly, the potential controllability can be more effectively enhanced.

The cells B4 to B7, which have a relatively high W ratio R in the active material among the cells B1 to B7, have peaks β appearing in the differential curves. The position of the maximum value of the peak β is a lithium ion charge ratio less than 25% and is on the low-lithium-ion-charge-ratio side of the peak β in the cells A3 to A7. Accordingly, these cells achieve better potential controllability throughout a lithium ion charge ratio range wider than those for the cells A3 to A7.

As discussed above, the differential curves of the cells A3 to A7 and B3 to B7 of Examples have a small peak α (for example, a maximum value less than 0.015) or no significant peak α. Thus, the change in potential is gentle (or substantially constant) at a lithium ion charge ratio of about 50% and sufficient potential controllability can be achieved at a lithium ion charge ratio of about 50%. Accordingly, compared to the cells C1 and C2 that use the active materials of related art, sufficient potential controllability is achieved throughout a wide lithium ion charge ratio range.

When the value of the differential curve is suppressed to a low level in a particular range of the lithium ion charge ratio, the potential controllability can be improved within that range and thus a more significant effect can be obtained. A specific description of this is provided below.

When the value of the differential curve (absolute value of the differential value) is less than the maximum value of the cells C1 and C2 of Comparative Examples (maximum value of the peak α), for example, less than 0.03, in the high-lithium-ion-charge-ratio side of the approximate lower limit position (for example, 35%) of the peak α, potential controllability higher than related art can be achieved. Desirably, the value of the differential curve in the region of a lithium ion charge ratio higher than 35% is less than 0.015. In this case, the potential controllability can be more effectively enhanced.

The maximum value of the peak β is less than 0.03 in all the cells that use the active materials of Examples. Thus, despite the presence of the peak β in the differential curve, the change in potential in that region is relatively gentle and sufficient charge controllability can be ensured. In particular, when the position of the maximum value of the peak β is on the low lithium ion charge ratio side (for example, a lithium ion charge ratio less than 25%), the value of the differential curve can be further suppressed to a low level in the region on the high-lithium-ion-charge-ratio side of the peak β (for example, the region at a lithium ion charge ratio exceeding 25%). Thus, potential controllability can be further enhanced in a wider lithium ion charge ratio range.

Table 1 indicates whether the value of the differential curve of each evaluation cell is less than 0.03 or less than 0.015 in the region of the lithium ion charge ratio higher than 35% and whether the value of the differential curve of each evaluation cell is less than 0.03 or 0.02 in the region of the lithium ion charge ratio higher than 25%. If the value of the differential curve is less than 0.03, 0.02 or 0.015, YES is indicated in the corresponding box and if it is not, NO is indicated in the corresponding box. As apparent from the evaluation results in Table 1, the cells A3 to A7 of Examples have three YES and no peak α. The cells B3 and B7 have four YES. The values of these cells indicate that the potential controllability is improved compared to the values of the cells C1, C2, B1, and B2 of Comparative Examples. In particular, the cells B3 to B7 that use the active material B have a value of the differential curve less than 0.02 in the region of the lithium ion charge ratio higher than 25% (four YES) and this indicates that the potential controllability is more effectively enhanced.

FIG. 6 is a ternary graph indicating the composition of the active material of each Example and each Comparative Example and the evaluation results for the potential controllability of the cells that use the active materials. The apexes of the ternary graph indicate 100% W, 100% Ti, and 100% Mo, respectively. Different marks are used to indicate the evaluation results for the differential curves of cells that use different active materials. To be more specific, solid circles are used to indicate the cell having four YES in the evaluation results of Table 1, solid triangles are used to indicate the cell having three YES in the evaluation results of Table 1 and no peak α, and open squares are used to indicate the cell having two or less YES, or “Charge failure”, or three YES with a peak α.

Although not included in Table 1, the same evaluation was conducted on the active materials (Mo(y)Ti(z)) that contained Ti and Mo but substantially no W. It was found that potential controllability was not satisfactory. The compositions of the active materials subjected to evaluation and the evaluation results are also indicated in FIG. 6 as Reference Examples.

As described by using the charge curves and the differential curves of the respective evaluation cells, the cells A3 to A7 and B3 to B7 having high potential controllability as described above all have good potential controllability during discharging as well.

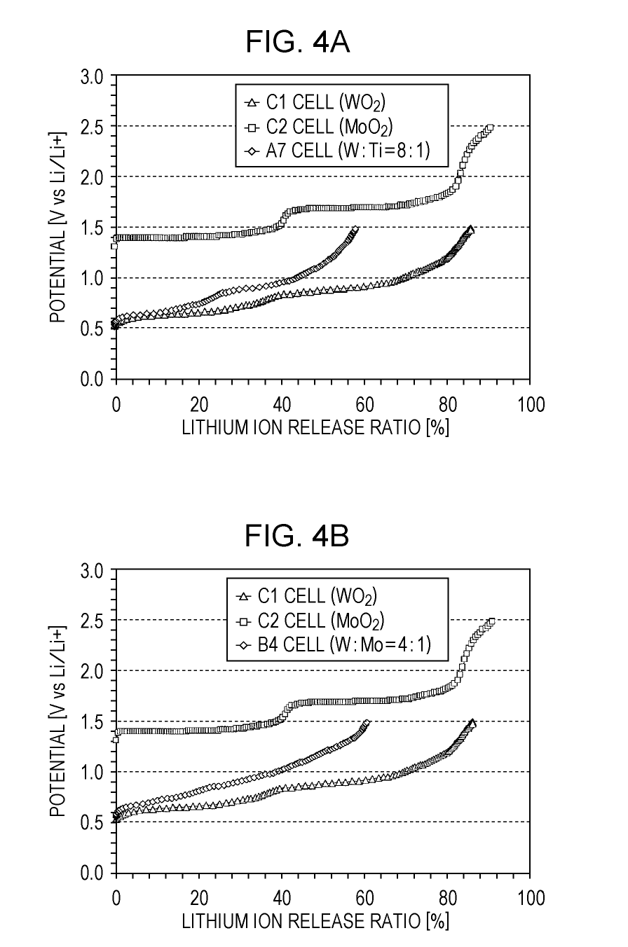

FIGS. 4A and 4B are graphs indicating the discharge curves of the cells A7 and B4, respectively, on the second cycle. The graphs also include discharge curves of the cells C1 and C2 of Comparative Examples for comparison purposes. The horizontal axis of the graph indicates the lithium ion release ratio from the time when discharge started. Since the lithium ion charge ratio at the time when discharge starts differs for each evaluation cell, the lithium ion release ratio from the start of discharging was determined from the time integration of the current as with the case of the charge ratio.

FIGS. 4A and 4B indicate that the discharge curve of the cell C2 (active material: MoO₂) has a region where the potential changes rapidly. In contrast, the discharge curves of the cell A7, the cell B4 and the cell C1 are relatively gentle. In particular, the discharge curve of the cell B4 is gentler than that of the cell C1. Although not indicated in the graph, the cells A3 to A6, B3, and B5 to B7 also have similar gentle discharge curves.

As discussed above, the active materials of this embodiment have charge-discharge properties in which rapid changes in oxidation-reduction potential associated with charging and discharging (intercalation and deintercalation of lithium ions) are suppressed. Accordingly, rapid changes in voltage during charging and discharging is suppressed by using an active material of this embodiment and a lithium ion secondary battery with good voltage controllability can be offered.

FIGS. 2A to 4B indicate that the active materials of this embodiment have a low potential. Specifically, the potential region mainly involved in charging and discharging is 1.0 V or less. Thus, a lithium ion secondary battery that uses an active material of this embodiment in the negative electrode can maintain enough voltage between the positive electrode and negative electrode and suppress the decrease in energy density.

Table 1 also indicates the potential (denoted as “Potential I” in Table 1) at the time the potential decrease typically occurring at the early stage of charging substantially ends and the potential (denoted as “Potential II” in Table 1) at a lithium ion charge ratio of 35%. These potentials were measured during the second-cycle of charging of each evaluation cell. The potential at which the value of the differential curve of the charge curve of the second cycle became lower than 0.02 for the first time was assumed to be the potential I. The results indicate that the potentials I and II are 1.0 V or less for all cells A3 to A7 and B1 to B7.

As apparent from Table 1, the potential II is rarely dependent on the W and Ti ratios for the cells A3 to A7 that use the active material A. In particular, for the cells A3 to A6 having a composition satisfying 1/7≦z/x≦1/3, the potential II is within the range of 0.76 to 0.8 V and is substantially constant. Accordingly, in the case where the active material A is used, setting the W and Ti ratios to satisfy 1/7≦z/x≦1/3 helps increase the capacitance per gram of the active material while maintaining a particular low potential.

The cells B3 to B7 that use the active material B have a tendency to exhibit a lower potential II with the increase in the ratio of W to Mo. Thus, an active material that has a desired potential can be obtained by changing the ratio of W to Mo.

As discussed above, when the active materials of this embodiment are used, rapid changes in potential during charging and discharging are suppressed and thus good potential controllability can be realized throughout a lithium ion charge ratio range wider than in related art. It is also possible to enhance the potential controllability compared to related art. Thus, a lithium ion secondary battery whose voltage can be satisfactorily controlled can be provided by using an active material of this embodiment. Since the oxidation-reduction potential of the active material of this embodiment is 1.0 V or less, a lithium ion secondary battery that uses an active material of this embodiment in the negative electrode can maintain a voltage between the positive electrode and the negative electrode and degradation of energy density can be suppressed.

### Second Embodiment

An active material of a second embodiment has a composition represented by W(x)Mo(y)Ti(z)O₂ (where x+y+z=1, 0<y≦x, and 0<z≦0.1304). While the Mo content y is smaller than ½ of the W content x in the active material of the first embodiment, the Mo content y is set to be equal to or less than the W content x in the active material of the second embodiment. That is, in the second embodiment, Ti is added to W and Mo to widen the range of the Mo content y. As described below, the advantageous effects of this disclosure can be achieved with the active material of the second embodiment as well as with the active material of the first embodiment. The active material of the second embodiment may have contents x, y, and z satisfying the range of the first embodiment. In other words, the contents x, y, and z may satisfy 0<max{y,z}/x<1/2 in addition to satisfying x+y+z=1, 0<y≦x, and 0<z≦0.1304.

According to the active material having the aforementioned composition (this active material is hereinafter referred to as an “active material D”), rapid changes in oxidation-reduction potential with respect to lithium metal (hereinafter simply referred to as “potential”) are suppressed during charging and discharging and good potential controllability is achieved. A lithium ion secondary battery with good voltage controllability can be realized by using the active material of the second embodiment.

When the active material D has the above-described composition, the potential is higher than 0 V but not higher than 1.0 V. Since the potential is higher than 0 V, precipitation of lithium metal can be suppressed. Since the potential is not higher than 1.0 V, a lithium ion secondary battery that uses the active material of this embodiment as the negative electrode material maintains a voltage between the positive electrode and the negative electrode and the decrease in energy density can be suppressed. Thus, when the active material of the second embodiment is used, precipitation of lithium metal can be suppressed and a lithium ion secondary battery having high energy density can be realized.

FIG. 9 is a ternary graph indicating x, y, and z (W content, Mo content, and Ti content) in the composition of the active material D. The apexes of the ternary graph respectively indicate 100% W (x=1), 100% Mo (y=1), and 100% Ti (z=1). A point located within the ternary graph indicates the W content x, the Mo content y, and the Ti content z (x+y+z=1, x>0, y>0, z>0). In the composition of the active material D, x, y, and z satisfy expression 1: 0<y≦x and expression 2: 0<z≦0.1304 as described above. The range of the Ti content z specified in expression 2 is a Ti content z of 15% or less relative to the total of W and Mo (z/(x+y)≦0.15 provided x+y+z=1).

The range that satisfies the expression 1, 0<y≦x, is the range in which the W content x is on or above a line L1 in the ternary graph, the line L1 representing y=x. The range that satisfies the expression 2, 0<z≦0.1304, is the range in which the Ti content z is on or below a line L2 in the ternary graph, the line L2 representing z=0.1304. Accordingly, x, y, and z in the composition of the active material D are within a range ra surrounded by the line L1, the line L2, a side representing y=0, and a side representing z=0. Note that the range ra includes points on the line L1 and the line L2 but not points on the sides representing y=0 and z=0.

In this embodiment, one or more other active materials may be used in addition to the active material having the composition described above. For example, a mixture of the active material described above and one or more other active materials may be used.

A rapid change in potential occurring at a lithium ion charge ratio of about 50% associated with use of an active material of related art can be reduced by using the active material D of this embodiment. When the active material D is used, a potential change different from one described above occurs in a region that extends from a lithium ion charge ratio of about 15% to 35%. However, good potential controllability is achieved on the high-lithium-ion-charge-ratio side of this region and throughout a lithium ion charge ratio range, including a lithium ion charge ratio of about 50%, wider than in related art. As described in detail below, when the active material D having a composition satisfying z/y≦1 is used, the position where the change in potential occurs at a lithium ion charge ratio of about 15% to 35% can be further shifted toward the lower lithium ion charge ratio side. Thus, the potential can be satisfactorily controlled throughout a further wider range.

The charge properties of active materials of related art and the active material D of the second embodiment will now be described with reference to drawings.

### Active Material of Related Art: WO₂ and MoO₂

As discussed above, active materials of related art, namely, WO₂ and MoO₂, have a problem in that rapid changes in voltage occur during charging.

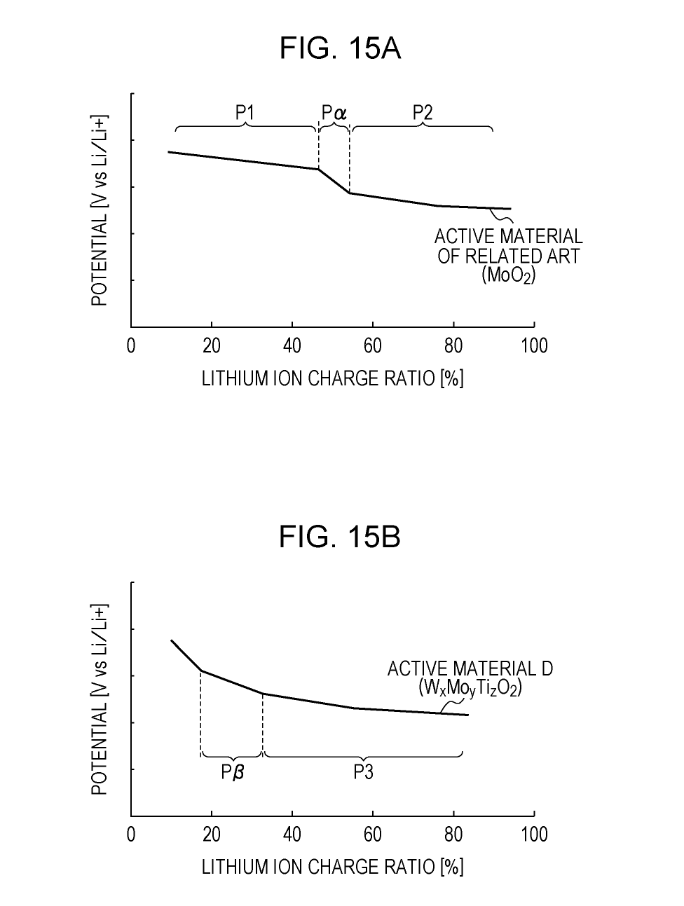

FIG. 15A is a graph schematically indicating an example of a charge curve of an active material (MoO₂) of related art. The graph in FIG. 15A is a model diagram illustrating a tendency of potential changes that occur during charging and the values of the potential (vertical axis) are not specified.

As schematically illustrated in FIG. 15A, the charge curve of MoO₂ has regions (plateaus) P1 and P2 where the potential changes relatively gently. The potential in the region P1 is higher than the potential in the region P2. A region Pα where the potential changes rapidly lies between the regions P1 and P2. The region Pα is positioned, for example, at a lithium ion charge ratio of about 50%. In such a case, the range of the lithium ion charge ratio in which sufficient potential controllability is obtained is the region on the high-lithium-ion-charge-ratio side of the region Pα, in other words, the range corresponding to the region P2 where the potential change is little. Although not illustrated, the charge curve of WO₂ also exhibits the same tendency.

Active Material D: W(x)Mo(y)Ti(z)O₂ (where x+y+z=1, 0<y≦x, and 0<z≦0.1304)

FIG. 15B is a graph schematically indicating an example of a charge curve of an active material D. Whereas a region Pα where the potential rapidly changes was observed at a lithium ion charge ratio of about 50% in the charge curve of MoO₂, the rapid change in voltage at a lithium ion charge ratio of about 50% was substantially absent in the charge curve of the active material D. However, a slightly rapid change in potential different from the potential change in the region Pα appeared in a region Pβ extending from a lithium ion charge ratio of about 15% to 35%. This potential change is more gentle than the potential change in the region Pα. A region (or plateau) P3 where the change in potential is gentle lies on the high-lithium-ion-charge-ratio side of the region Pβ. Thus, the range of the lithium ion charge ratio in which good potential controllability is obtained for the active material D is the range on the high-lithium-ion-charge-ratio side of the region Pβ, the range corresponding to a region P3 where the potential change is little. The range of the lithium ion charge ratio in the region P3 is wider than the range of the lithium ion charge ratio of the region P2 for the active material of related art. Accordingly, good potential controllability is achieved throughout a wider range of the lithium ion charge ratio.

### Method for Making Active Material D

Next, an example of a method for making an active material D of this embodiment is described.

In making the active material of this embodiment, tungsten dioxide (WO₂) is used as a tungsten (W) material, for example. Molybdenum dioxide (MoO₂) is used as a molybdenum (Mo) material, for example. Titanium dioxide (TiO₂) having a rutile structure or an anatase structure is used as a titanium (Ti) material.

The active material of this embodiment is obtained by, for example, pulverizing and mixing the raw materials described above and firing the resulting mixture in a reducing atmosphere. The firing temperature is set to, for example, a temperature of 700° C. or more and 1300° C. or less and desirably 1100° C. or more and 1200° C. or less. At an excessively low firing temperature, the reactivity is degraded and a longer firing time is necessary to obtain a single phase. At an excessively high firing temperature, the production cost is increased and the crystallinity may be lost due to fusing.

The method for making the active material is not limited to one described above. Any of various synthetic methods, such as hydrothermal synthesis, supercritical synthesis, and a co-precipitation process, may be employed instead of the aforementioned method.

### Structure of Lithium Ion Secondary Battery

Next, a structure of a lithium ion secondary battery that uses the active material of this embodiment is described. In this embodiment, it is sufficient if one of the electrodes of the lithium ion secondary battery contains the active material described above and the rest of the structure is not particularly limited.

A lithium ion secondary battery that uses the active material of this embodiment includes a negative electrode that contains the active material of this embodiment as the negative electrode active material, a positive electrode that contains an active material (positive electrode active material) that can intercalate and deintercalate lithium ions, a separator disposed between the positive electrode and the negative electrode, and an electrolyte having lithium ion conductivity.

The negative electrode includes a negative electrode current collector and a negative electrode mix supported on the negative electrode current collector. The negative electrode mix contains an active material (W(x)Mo(y)Ti(z)O₂ (where x+y+z=1, 0<y≦x, and 0<z≦0.1304) of this embodiment. The negative electrode mix may contain one or more other active materials, a binder, a conductive agent, and the like, in addition. The negative electrode can be prepared by, for example, mixing a negative electrode mix with a liquid component to prepare a negative electrode mix slurry, applying the slurry to a negative electrode current collector, and drying the applied slurry.

The blend ratios of the binder and the conductive agent relative to 100 parts by weight of the active material (negative electrode active material) of the negative electrode are desirably in the range of 1 part by weight or more and 20 parts by weight or less for the binder and 1 part by weight or more and 25 parts by weight or less for the conductive agent.

For example, stainless steel, nickel, copper, or the like is used as the negative electrode current collector. The thickness of the negative electrode current collector is not particularly limited and is desirably 1 to 100 μm and more desirably 5 to 20 μm. When the thickness of the negative electrode current collector is within the above-described range, weight reduction can be achieved while maintaining the strength of the electrode plate.

The positive electrode includes a positive electrode current collector and a positive electrode mix supported on the positive electrode current collector. The positive electrode mix may contain a positive electrode active material, a binder, a conductive agent, and the like. The positive electrode can be prepared by mixing the positive electrode mix with a liquid component to prepare a positive electrode mix slurry, applying the slurry to a positive electrode current collector, and drying the applied slurry.

Examples of the positive electrode material include complex oxides such as lithium cobaltate and modified lithium cobaltate (such as eutectic with aluminum and/or magnesium), lithium nickelate and modified lithium nickelate (such as lithium nickelate with nickel partly substituted with cobalt or manganese), and lithium manganate and modified lithium manganate; lithium iron phosphate and modified lithium iron phosphate; and lithium manganese phosphate and modified lithium manganese phosphate. These positive electrode active materials can be used alone or in combination.

Examples of the binder for the positive or negative electrode include PVDF, polytetrafluoroethylene, polyethylene, polypropylene, aramid resin, polyamide, polyimide, polyamideimide, polyacrylonitrile, polyacrylic acid, methyl ester of polyacrylic acid, ethyl ester of polyacrylic acid, hexyl ester of polyacrylic acid, polymethacrylic acid, methyl ester of polymethacrylic acid, ethyl ester of polymethacrylic acid, hexyl ester of polymethacrylic acid, polyvinyl acetate, polyvinylpyrrolidone, polyether, polyether sulfone, hexafluoropolypropylene, styrene butadiene rubber, and carboxymethyl cellulose. A copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can also be used. A mixture of two or more selected from the aforementioned materials can also be used. Examples of the conductive agent to be contained in the electrode include graphite materials such as natural graphite and artificial graphite, carbon blacks such as acetylene black, Ketjen black, channel black, furnace black, lamp black, and thermal black, conductive fibers such as carbon fibers and metal fibers, metal powders such as carbon fluoride and aluminum, conductive whiskers such as zinc oxide and potassium titanate, conductive metal oxides such as titanium oxide, and organic conductive materials such as phenylene derivatives.

The blend ratios of the binder and the conductive agent relative to 100 parts by weight of the positive electrode active material are 1 part by weight or more and 20 parts by weight or less for the binder and 1 part by weight or more and 25 parts by weight or less for the conductive agent.

For example, stainless steel, aluminum, titanium, or the like is used as the positive electrode current collector. The thickness of the positive electrode current collector is desirably 1 to 100 μm and more desirably 5 to 20 μm. When the thickness of the positive electrode current collector is within the above-described range, weight reduction can be achieved while maintaining the strength of the electrode plate. The thickness of the positive electrode current collector, however, is not particularly limited.

The separator disposed between the positive electrode and the negative electrode is, for example, a microporous thin film, a woven cloth, a nonwoven cloth, or the like that has sufficient permeability to ions and particular mechanical strength and insulating property. A microporous thin film may be a film composed of one material or a composite film or multilayered film composed of two or more materials. The material for the separator may be a polyolefin such as polypropylene or polyethylene. Since polyolefin has high durability and a shut-down function, the reliability and safety of the lithium ion secondary battery can be further enhanced by using a polyolefin. The thickness of the separator is, for example, 10 to 300 μm, desirably 10 to 40 μm, and more desirably 10 to 25 μm. The porosity of the separator is desirably in the range of 30% to 70% and more desirably in the range of 35% to 60%. The “porosity” refers to the volume ratio of pores (voids) relative to the entire separator.

A liquid, gel, or solid substance can be used as the electrolyte.

A liquid nonaqueous electrolyte (nonaqueous electrolyte solution) is obtained by dissolving an electrolyte (for example, a lithium salt) in a nonaqueous solvent. A gel nonaqueous electrolyte contains a nonaqueous electrolyte and a polymer material that supports the nonaqueous electrolyte. Examples of the polymer material include polyvinylidene fluoride, polyacrylonitrile, polyethylene oxide, polyvinyl chloride, polyacrylate, and polyvinylidene fluoride hexafluoropropylene.

A known nonaqueous solvent can be used as the nonaqueous solvent in which an electrolyte is to be dissolved. The nonaqueous solvent may be of any type and may be, for example, a cyclic carbonate, a linear carbonate, or a cyclic carboxylate. Examples of the cyclic carbonate include propylene carbonate (PC) and ethylene carbonate (EC). Examples of the linear carbonate include diethyl carbonate (DEC), ethyl methyl carbonate (EMC), and dimethyl carbonate (DMC). Examples of the cyclic carboxylate include γ-butyrolactone (GBL) and γ-valerolactone (GVL). These nonaqueous solvents can be used alone or in combination.

Examples of the electrolyte to be dissolved in the nonaqueous solvent include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic carboxylic acid lithium, LiCl, LiBr, LiI, chloroborane lithium, borates, and imide salts. Examples of the borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium (5-fluoro-2-olate-1-benzenesulfonate-O,O′)borate. Examples of the imide salts include lithium bistrifluoromethanesulfonimide ((CF₃SO₂)₂NLi), lithium (trifluoromethanesulfonyl)(nonafluorobutanesulfonyl)imide (LiN(CF₃SO₂)(C₄F₉SO₂)), and lithium bispentafluoroethanesulfonimide ((C₂F₅SO₂)₂NLi). These electrolytes may be used alone or in combination.

The nonaqueous electrolyte solution may contain, as an additive, a material that decomposes on the negative electrode, forms a film having high lithium ion conductivity, and enhances the charge-discharge efficiency. Examples of the additive having such functions include vinylidene carbonate (VC), 4-methylvinylidene carbonate, 4,5-dimethylvinylidene carbonate, 4-ethylvinylidene carbonate, 4,5-diethylvinylidene carbonate, 4-propylvinylidene carbonate, 4,5-dipropylvinylidene carbonate, 4-phenylvinylidene carbonate, 4,5-diphenylvinylidene carbonate, vinyl ethylene carbonate (VEC), and divinyl ethylene carbonate. These may be used alone or in combination. Of these, the additive is desirably at least one selected from the group consisting of vinylidene carbonate, vinyl ethylene carbonate, and divinyl ethylene carbonate. These compounds may have some hydrogen atoms substituted with fluorine atoms. The amount of the electrolyte dissolved in the nonaqueous solvent is desirably in the range of 0.5 to 2 mol/L.

A known benzene derivative that, at the time of overcharging, decomposes and forms a film on the electrode to inactivate the battery may be added to the nonaqueous electrolyte. The benzene derivative may contain a phenyl group and a cyclic compound group adjacent to the phenyl group. The cyclic compound group may be a phenyl group, a cyclic ether group, a cyclic ester group, a cycloalkyl group, or a phenoxy group, for example. Specific examples of the benzene derivative include cyclohexylbenzene, biphenyl, and diphenyl ether. These may be used alone or in combination. The benzene derivative content is desirably 10% by volume or less of the entire nonaqueous solvent.

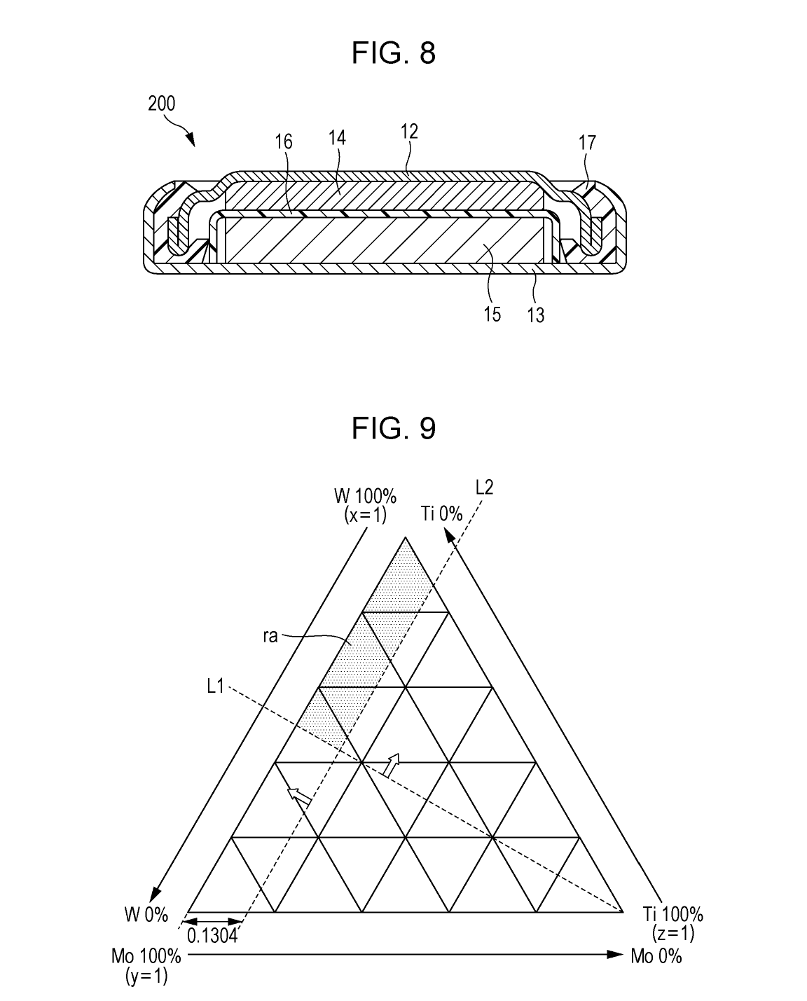

FIG. 8 is a schematic cross-sectional view illustrating an example of a lithium ion secondary battery 200 having a coin shape.

The lithium ion secondary battery 200 includes an electrode assembly that includes a negative electrode 14, a positive electrode 15, and a separator 16. The negative electrode 14 and the positive electrode 15 are arranged so that the negative electrode mix faces the positive electrode mix. The separator 16 is disposed between the negative electrode 14 and the positive electrode 15 (between the negative electrode mix and the positive electrode mix). The electrode assembly is impregnated with an electrolyte (not illustrated) having lithium ion conductivity. The positive electrode 15 is electrically connected to a battery case 13 that serves as a positive electrode terminal. The negative electrode 14 is electrically connected to a sealing plate 12 that serves as a negative electrode terminal. The opening end of the battery case 13 is clamped with a gasket 17 disposed at the periphery of the sealing plate 12 and thus the whole battery is hermetically sealed. Although the battery in FIG. 8 has a coin shape, the lithium ion secondary battery according to this embodiment is not limited to one having a coin shape, and may have a button shape, a sheet shape, a cylinder shape, a flat shape, or a rectangular shape.

### Examples

Active materials of Examples were prepared and evaluated. The method and results are described below.

### (1) Preparation of Active Material

Raw material powders of WO₂, MoO₂, and TiO₂ at a molar ratio indicated in Table 2 were thoroughly mixed by using an agate mortar. The resultant mixture was fired at 1200° C. for 8 hours in a reducing atmosphere containing a hydrogen-carbon dioxide gas (1:1 on a molar basis) mixture. As a result, active materials D1 to D16 were obtained. Among the active materials D1 to D16, D2 to D6 and D8 to D16 are active materials of Examples that have a composition represented by W(x)Mo(y)Ti(z)O₂ (where x+y+z=1, 0<y≦x, and 0<z≦0.1304). The active materials D1 and D7 are active materials of Comparative Examples that have a composition represented by W(x)Mo(y)Ti(z)O₂ but do not satisfy 0<z≦0.1304.

For the purpose of comparison, active materials E1 and E2 each containing only two metal elements selected from W, Mo, and Ti and active materials C1 and C2 each containing only one metal element selected from the aforementioned metals were prepared by the same method. The active material E1 is a metal oxide (W_{0.5}Mo_{0.5}O₂) containing W and Mo but substantially no Ti and the active material E2 is a metal oxide (W_{0.5}Ti_{0.5}O₂) that contains W and Ti but substantially no Mo. The active material C1 is WO₂ and the active material C2 is MoO₂.

Each of the active materials of Examples and Comparative Examples was analyzed through X-ray diffractometry (XRD). The results found that in all active materials, WO₂, MoO₂, and TiO₂ formed a solid solution without undergoing phase separation and formed a single phase free of by-products. Accordingly, the molar ratios of the raw materials directly correspond to the composition ratios of each active material. The composition of each active material is indicated in Table 2.

TABLE 2

| | Mixing molar ratio of active | | | | | | | | | | | |
|---|---|---|---|---|---|---|---|---|---|---|---|---|
| | material | | | Composition of active material | | | | | Peak α | | Peak β | |
| | W | Mo | Ti | W | Mo | Ti | | | Position | Maximum | Position | Maximum |
| Cell | (x) | (y) | (z) | (x) | (y) | (z) | z/(x + y) | z/y | (%) | value | (%) | value |
| D1 | 6 | 1 | 5 | 0.500 | 0.083 | 0.417 | 0.714 | 5.000 | | | | |
| D2 | 6 | 1 | 1 | 0.750 | 0.125 | 0.125 | 0.143 | 1.000 | 40.9 | 0.010 | 22.1 | 0.012 |
| D3 | 6 | 1 | 0.1 | 0.845 | 0.141 | 0.014 | 0.014 | 0.100 | 42.2 | 0.007 | 17.7 | 0.019 |
| D4 | 6 | 0.1 | 0.9 | 0.857 | 0.014 | 0.129 | 0.148 | 9.000 | None | None | 25.3 | 0.024 |
| D5 | 6 | 0.5 | 0.5 | 0.857 | 0.071 | 0.071 | 0.077 | 1.000 | None | None | 19.1 | 0.021 |
| D6 | 6 | 0.7 | 0.3 | 0.857 | 0.100 | 0.043 | 0.045 | 0.429 | None | None | 18.2 | 0.016 |
| D7 | 9 | 1 | 5 | 0.600 | 0.067 | 0.333 | 0.500 | 5.000 | | | | |
| D8 | 9 | 1 | 1 | 0.818 | 0.091 | 0.091 | 0.100 | 1.000 | 43.0 | 0.007 | 22.7 | 0.016 |
| D9 | 9 | 1 | 0.5 | 0.857 | 0.095 | 0.048 | 0.050 | 0.500 | 43.7 | 0.007 | 19.6 | 0.017 |
| D10 | 9 | 1 | 0.1 | 0.891 | 0.099 | 0.010 | 0.010 | 0.100 | 36.8 | 0.006 | 16.4 | 0.029 |
| D11 | 9 | 0.1 | 0.9 | 0.900 | 0.010 | 0.090 | 0.099 | 9.000 | None | None | 26.9 | 0.022 |
| D12 | 9 | 0.5 | 0.5 | 0.900 | 0.050 | 0.050 | 0.053 | 1.000 | None | None | 21.2 | 0.022 |
| D13 | 9 | 0.7 | 0.3 | 0.900 | 0.070 | 0.030 | 0.031 | 0.429 | None | None | 18.6 | 0.025 |
| D14 | 9 | 0.9 | 0.1 | 0.900 | 0.090 | 0.010 | 0.010 | 0.111 | None | None | 17.9 | 0.027 |
| D15 | 1 | 1 | 0.05 | 0.488 | 0.488 | 0.024 | 0.025 | 0.050 | 35.4 | 0.008 | 22.3 | 0.014 |
| D16 | 1 | 1 | 0.01 | 0.498 | 0.498 | 0.005 | 0.005 | 0.010 | 35.5 | 0.007 | 18.0 | 0.026 |
| E1 | 1 | 1 | 0 | 0.500 | 0.500 | 0.000 | | | 48.4 | 0.030 | None | None |
| E2 | 1 | 0 | 1 | 0.500 | 0.000 | 0.500 | | | | | | |
| C1 | 1 | 0 | 0 | 1.000 | 0.000 | 0.000 | | | 49.9 | 0.033 | None | None |
| C2 | 0 | 1 | 0 | 0.000 | 1.000 | 0.000 | | | 48.4 | 0.034 | None | None |

| | Value of | Value of | Value of | Value of | | |
|---|---|---|---|---|---|---|
| | differential | differential | differential | differential | | |
| | curve at | curve at | curve at | curve at | | Potential II |
| | charge ratio | charge ratio | charge ratio | charge ratio | | (at charge |
| | above 35%: | above 35%: | above 25%: | above 25%: | Potential I | ratio of 35%) |
| Cell | Less than 0.03 | Less than 0.015 | Less than 0.03 | Less than 0.02 | [V] | [V] |
| D1 | | | | | Charge | Charge |
| | | | | | failure | failure |
| D2 | YES | YES | YES | YES | 0.96 | 0.75 |
| D3 | YES | YES | YES | YES | 0.87 | 0.68 |
| D4 | YES | YES | YES | NO | 0.82 | 0.67 |
| D5 | YES | YES | YES | YES | 0.84 | 0.67 |
| D6 | YES | YES | YES | YES | 0.79 | 0.67 |
| D7 | | | | | Charge | Charge |
| | | | | | failure | failure |
| D8 | YES | YES | YES | YES | 0.86 | 0.73 |
| D9 | YES | YES | YES | YES | 0.83 | 0.69 |
| D10 | YES | YES | YES | YES | 0.89 | 0.67 |
| D11 | YES | YES | YES | NO | 0.84 | 0.72 |
| D12 | YES | YES | YES | YES | 0.82 | 0.63 |
| D13 | YES | YES | YES | YES | 0.84 | 0.65 |
| D14 | YES | YES | YES | YES | 0.85 | 0.64 |
| D15 | YES | YES | YES | YES | 0.97 | 0.75 |
| D16 | YES | YES | YES | YES | 0.92 | 0.67 |
| E1 | NO | NO | NO | NO | 0.97 | 0.96 |
| E2 | | | | | Charge | Charge |
| | | | | | failure | failure |
| C1 | NO | NO | NO | NO | 1.12 | 0.82 |
| C2 | NO | NO | NO | NO | 1.80 | 1.58 |

### (2) Preparation of Electrode

Electrodes were made by using the active materials obtained by the methods described above. Specifically, 100 parts by weight of the active material, 10 parts by weight of acetylene black serving as a conductive agent, 10 parts by weight of polyvinylidene fluoride serving as a binder, and an appropriate amount of N-methyl-2-pyrrolidone (NMP) solution serving as a dispersion medium were mixed to prepare a mix paste.

The mix paste was applied to a surface of a current collector and dried to form an active material layer. A copper foil having a thickness of 18 μm was used as the current collector. Then the current collector with the active material layer formed thereon was subjected to flat-plate pressing at 2 ton/cm² and compressed until the total thickness of the current collector and the active material layer was reduced to 100 μm. A round piece having a diameter of 12.5 mm was punched out from the current collector with the active material layer thereon to form an electrode.

### (3) Preparation of Counter Electrode

A round piece having a diameter of 14.5 mm was punched out from a Li foil having a thickness of 300 μm to form a counter electrode.

### (4) Preparation of Nonaqueous Electrolyte

In a mixed solvent containing ethylene carbonate and ethyl methyl carbonate at a volume ratio of 1:3, LiPF₆ serving as a solute was dissolved to a concentration of 1.0 mol/L so as to obtain a nonaqueous electrolyte.

### (5) Preparation of Evaluation Cells

A cell for evaluation was prepared by using the electrode described above as a working electrode and the Li foil as the counter electrode.

Each evaluation cell had a structure illustrated in FIG. 8. The battery case 13 and the sealing plate 12 were made by processing a stainless steel plate having resistance to organic electrolyte solutions. The negative electrode 14 (serving as a working electrode 14) was one of the electrodes described above and the positive electrode 15 (serving as a counter electrode 15) was the Li foil described above. In each evaluation cell, a part of the battery case 13 functioned as a current collector. A microporous polypropylene separator was used as the separator 16 and a polypropylene resin insulating gasket was used as the gasket 17.

In Examples, the Li foil was spot-welded onto an inner surface of the battery case 13 to obtain a counter electrode 15. A separator 16 was then placed on the counter electrode 15 and a nonaqueous electrolyte was placed in the separator 16. The electrode described above serving as the working electrode 14 was press-bonded onto the inner side of the sealing plate 12. The sealing plate 12 with the working electrode 14 press-bonded thereon was fitted into the opening of the battery case 13 with the gasket 17 therebetween and the opening was sealed. As a result, an evaluation cell having a coin shape was obtained.

In this specification, an evaluation cell that uses, as the working electrode 14, an electrode prepared by using the active material D1 in Table 2 is named “cell D1”. Similarly, evaluation cells that use, as working electrodes 14, electrodes prepared by using the active materials D2 to D16, E1, E2, C1, and C2 are also named according to the reference numbers of the active materials.

### (6) Evaluation of Charge-Discharge Properties

The evaluation cells were subjected to charge-discharge cycle testing to measure the charge-discharge properties. To be specific, the cycle that included charging the cell in a room temperature environment at a constant current of 0.1 mA until a voltage of 0.5 V was reached and then discharging the cell at a constant current of 0.1 mA until a voltage of 1.5 V was reached to deintercalate the lithium ions from the active material was repeated. However, because the cell C2 that used the active material C2 including only MoO₂ constantly had a potential higher than 0.5 V, charging was conducted until the lithium ion charge ratio was about 90% and discharging was conducted until 2.5 V was reached.

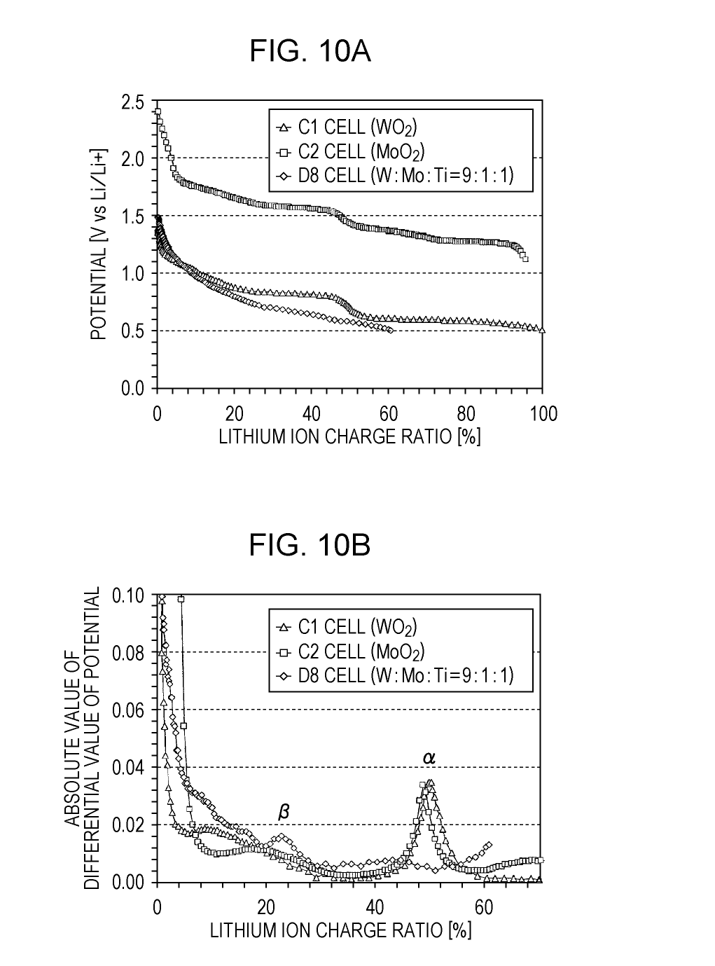

The measurement results of the charge-discharge properties will now be described with reference to FIGS. 10A and 10B.

FIGS. 10A and 10B are graphs respectively indicating a charge curve and a differential curve of the charge curve of the cell D8 that used the active material D8 indicated in Table 2 on the second cycle. For comparison, the charge curves and differential curves of the cells C1 and C2 that used the active material C1 (WO₂) and the active material C2 (MoO₂) of Comparative Examples are also indicated in these graphs.

FIG. 10A indicates a charge curve plotted on the horizontal axis indicating the lithium ion charge ratio relative to the active material and the vertical axis indicating the potential (potential with respect to lithium metal) of the electrode (working electrode 14). The lithium ion charge ratio was determined from the time integration of the current based on the assumption that the current flowing in the cell was completely involved in lithium ion intercalation and deintercalation for the active material and is indicated as a percentage value where 100% corresponds to the compositional ratio, Li(1)W(x)Mo(y)Ti(z)O₂ (where x+y+z=1).

The differential curve in FIG. 10B was plotted on the horizontal axis indicating the lithium ion charge ratio and the vertical axis indicating the absolute value of the differential value of the potential with respect to the lithium ion charge ratio. Each differential curve was obtained by dividing the difference in potential between two adjacent measurement points on a charge curve with a difference in lithium ion charge ratio and plotting the absolute values of the results. The intervals along the horizontal axis (lithium ion charge ratio) between adjacent plots in the differential curve were set to 0.28% or more and 1.6% or less.

The inflection point of the charge curve in FIG. 10A appears as a peak in the differential curve in FIG. 10B. The larger the maximum value of the peak and the smaller the half-width, the more rapid the change in potential between before and after the inflection point. The value on the vertical axis of the differential curve (absolute value of the differential value, hereinafter simply referred to as “a value of the differential curve”) is the slope of the potential at that charge ratio. Accordingly, the smaller the value of the differential curve, the more gentle the change in potential. The intervals between adjacent two plots of the differential curve along the horizontal axis (lithium ion charge ratio) are not particularly limited. For example, when the intervals are 2% or less (more than 0% but not more than 2%), the position and maximum value of the peak and the peak shape can be more reliably studied.

FIG. 10A indicates that the charge curves of the cells C1 and C2 of Comparative Examples have a rapid change in potential at a lithium ion charge ratio of about 50%. This change appears as a peak α in the differential curve in FIG. 10B. In contrast, the charge curve of the cell D8 of Example has a relatively gentle change in potential at a lithium ion charge ratio of about 50% but a relatively large change in potential at a lithium ion charge ratio of about 20% to 25%. The latter change appears as a peak β in the differential curve in FIG. 10B. As FIG. 10B indicates, the peak β of the cell D8 is smaller than the peaks α of the cells C1 and C2, and is broad. Note that the peak is “small” when the maximum value of the peak in the differential curve is small. This result confirms that the relatively rapid change in potential that occurs during charging of the cell D8 is smaller than the change in potential occurring in the cells C1 and C2 and takes place in the region with a lower lithium ion charge ratio. The high-lithium-ion-charge-ratio side of the region where the potential change occurs is a region (plateau) where the change in potential is relatively gentle. Accordingly, the cell D8 can achieve good negative electrode potential (or battery voltage) controllability in a lithium ion charge ratio range wider than those for the cells C1 and C2.

The charge curve of the cell D8 in FIG. 10A is shorter than the charge curves of the cells C1 and C2. This is because the end-of-charge potential (equals the potential of the electrode with respect to the lithium metal in this example) was set to 0.5 V in the measurement of the charge-discharge properties. The charge curves of the cell D7 and the cell E4 had a significant change in potential immediately before the potential reached 0.5 V. This is due to the operation of ending the charging (cut-off operation).

At least one peak was observed in each of the differential curves of the cells D2 to D6, D8 to D16, E1, C1, and C2. These peaks were studied and were categorized into three peaks, namely, peaks α, peaks β, and peaks γ, according to the position (lithium ion charge ratio) of the peak and the peak shape:
Peak α: A peak α can appear in the lithium ion charge ratio range of about 35% to 60%. For the cell C1 (active material: WO₂) and the cell C2 (active material: MoO₂) of Comparative Examples, the peak α is sharp with a maximum value exceeding 0.03, which indicates that a significantly rapid change in potential is occurring (refer to FIG. 10B). In contrast, for the cells D2 to D6 and D8 to D16 that used the active materials of Examples, either the peak α is practically absent or the peak α is clearly smaller than the peaks α of the cells C1 and C2 and is broad.
Peak β: A peak β can appear in the lithium ion charge ratio range of about 15% to 35%. This peak does not appear for the cells C1 and C2 of Comparative Examples and appears only in the differential curves of the cells D2 to D6 and D8 to D16 that contain the active materials of Examples. The peak profile of the peak β is linear compared to that of the peak α and the peak γ.
Peak γ: A peak γ can appear in the lithium ion charge ratio range of about 5% to 15%. The shape of the peak γ is distorted compared to the peaks α and β.

Among these peaks, the peak γ is located in an early stage of charging and it is possible that the change in potential is caused by various side reactions resulting in appearance of the peak. Accordingly, only the peaks α and β present in the practical operation range of the lithium ion charge ratio are focused in this specification and the relationship between these peaks and the composition of the active material is investigated.

The maximum values of the peaks α and β of the respective evaluation cells and the positions of the peaks (lithium ion charge ratios at which the maximum values of the peaks lie) of the respective evaluation cells are described in Table 2. The relationship between these values and the composition of the active material was investigated and the following was found.

For the cells D1, D7 and E2 that used active materials having a high Ti content, charging was either not conducted at all or ended at a lithium ion charge ratio of 20% or less (this is indicated as “Charge failure” in Table 2). In contrast, the cells E2, C1, and C2 that used the active materials not containing Ti and the cells D2 to D6 and D8 to D16 that used the active materials with a relatively low Ti content z while satisfying z≦0.1304 could at least be charged until the potential reached the end-of-charge potential of 0.5 V and the charging could be carried out until the lithium ion charge ratio exceeded 35%.

As is apparent from FIG. 10B and Table 2, the differential curves of the cells E1, C1, and C2 of Comparative Examples have peaks α with a maximum value of 0.03 or more. In contrast, the differential curves of the cells D2 to D6 and D8 to D16 of Examples have no significant peak α or if the curves have any peaks α, the maximum values of these peaks are clearly smaller than the maximum values of the peaks α of the cells E1, C1, and C2. In contrast, the differential curves of the cells D2 to D6 and D8 to D16 have peaks β. The maximum values of the peaks β are within the lithium ion charge ratio range of about 15% to 30%. Based on these results, it was found that the cells D2 to D6 and D8 to D16 that use the active materials with a relatively low Ti content can use a wider plateau on the high-lithium-ion-charge-ratio side of the peak β. Accordingly, the potential can be stably controlled relative to the lithium ion charge ratio throughout a wider range of lithium ion charge ratio and good potential controllability can be achieved.

The relationship between the position of the peak β and the composition of the active material was investigated and found to be as follows.

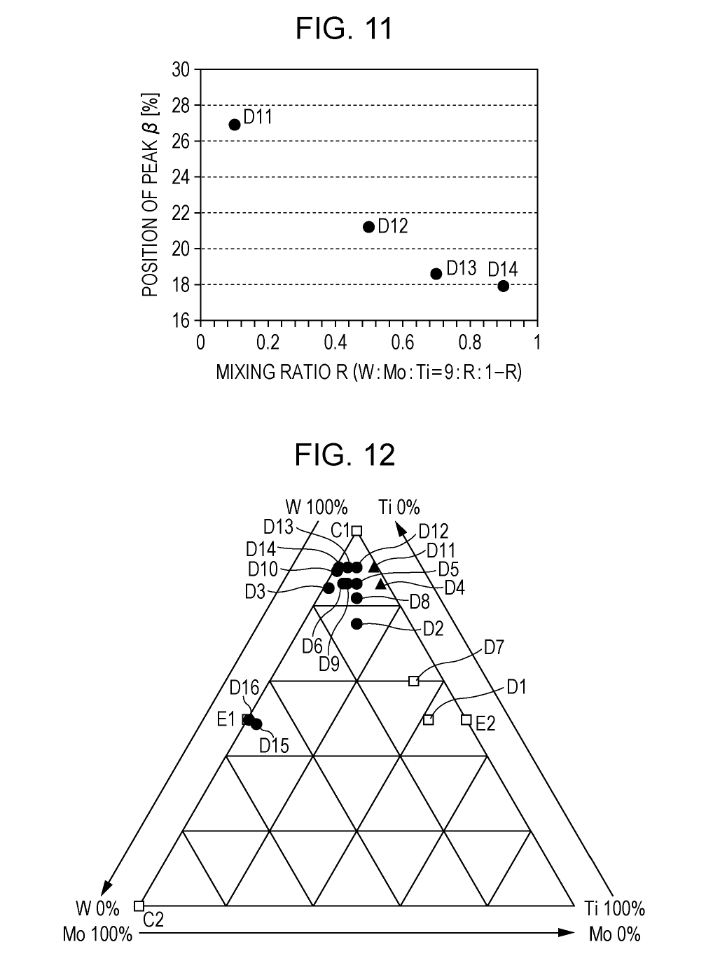

FIG. 11 is a graph indicating the relationship between the mixing ratio R (W:Mo:Ti=9:R:1-R) in each of the active materials of the cells D11 and D14 and the position of the peak β. As apparent from FIG. 11, the larger the mixing ratio R (in other words, the higher the Mo content), the more the position of the peak β of each cell shifted toward the low-lithium-ion-charge-ratio side. For example, the peaks β of the cells D12 to D14 in which the Ti content z is not more than the Mo content y (R: 0.5 or more) are positioned at a lithium ion charge ratio less than 25% and thus the region where the potential change is small can be further enlarged after the peak β (the high-lithium-ion-charge-ratio side of the peak β).

Although FIG. 11 indicates only the relationship between the mixing ratio R and the peaks β of some of the cells, the same tendency is observed in other cells also. In particular, as apparent from the results in Table 2, the peaks β of the cells D4 and D11 having a Ti content z larger than the Mo content y are positioned at a lithium ion charge ratio of 25% or more. In contrast, the peaks β of the cells with a Ti content z of not more than the Mo content y (z/y≦1) are positioned at a low-lithium-ion-charge-ratio side (lithium ion charge ratio less than 25%) compared to the cells D4 and D11. This confirms that when the compositional ratio of the active material satisfies z/y≦1, the range in which good potential controllability is obtained can be effectively expanded.

The results described above indicate that in the cells D2 to D6 and D8 to D16 in which the Ti content z is relatively low and is equal to or lower than 15% of the total of the W content x and the Mo content y (z/(x+y)≦0.15) (since x+y+z=1, z≦0.1304), the change in potential that occurs at a lithium ion charge ratio of about 50% is gentle (or substantially absent) and thus sufficient potential controllability can be achieved at a lithium ion charge ratio of about 50%. Accordingly, sufficient potential controllability can be obtained throughout a wider lithium ion charge ratio range compared to the cells E1 C1, and C2 that use the active materials of related art. In particular, it becomes possible to shift the position of the peak β toward a low-lithium-ion-charge-ratio side to below a lithium ion charge ratio less than 25% in the cells D2, D3, D5, D6, D8 to D10, and D12 to D16 in which the Ti content z is not more than the Mo content y and this indicates that a further wide range of lithium ion charge ratio can be used.

When the value of the differential curve is suppressed to a low level in a particular range of lithium ion charge ratio, the potential controllability can be improved within that range and thus a more notable effect can be achieved. The specific description therefor is provided below.

When the value of the differential curve (absolute value of the differential value) is less than the maximum value of the cells C1 and C2 of Comparative Examples (maximum value of the peak α), for example, less than 0.03, in the high-lithium-ion-charge-ratio side of the approximate lower limit position (for example, 35%) of the peak α, potential controllability higher than related art can be achieved. More desirably, the value of the differential curve in the region where the lithium ion charge ratio is higher than 35% is less than 0.015. In this case, the potential controllability can be more effectively enhanced. Since the maximum value of the peak β is as low as less than 0.03 as indicated in Table 2, the value of the differential curve can be suppressed to a low level despite the presence of the peak β. However, the value of the differential curve can be further decreased in the region where the lithium ion charge ratio is higher than 25% when the maximum value of the peak β is positioned on the low-lithium-ion-charge-ratio side (for example, less than a lithium ion charge ratio of 25%). Thus, the potential controllability can be more effectively enhanced throughout a wider lithium ion charge ratio range.

Table 2 indicates whether the value of the differential curve of each evaluation cell is less than 0.03 or 0.015 in the region where the lithium ion charge ratio is higher than 35% and whether the value of the differential curve of each evaluation cell is less than 0.03 or 0.02 in the region where the lithium ion charge ratio is higher than 25%. When the value of the differential curve is less than 0.03, 0.02 or 0.015, YES is indicated in the corresponding box and when it is not, NO is indicated in the corresponding box. The evaluation results in Table 2 indicate that the cells D2 to D6 and D8 to D16 that used active materials of Examples have three or more YES and have improved potential controllability compared to the cells C1, C2, and E2. It can also be understood from the results that the potential controllability of the cells that use the active materials having a Ti content z not more than the Mo content y (in other words, the composition ratio satisfies z/y≦1) can be more effectively enhanced since the value of the differential curve is less than 0.02 (four YES) in the region where the lithium ion charge ratio is higher than 25%.

FIG. 12 is a ternary graph indicating the composition of the active material of each Example and each Comparative Example and the evaluation results of the potential controllability of the cells that use the active materials. The apexes of the ternary graph indicate 100% W (x=1), 100% Ti (z=1), and 100% Mo (y=1), respectively. Different marks are used to indicate the evaluation results for the differential curves of cells that use different active materials in FIG. 12. To be more specific, solid circles are used to indicate the cell having four YES in the evaluation results of Table 2, solid triangles are used to indicate the cell having three YES in the evaluation results of Table 2, and open squares are used to indicate the cell having two or less YES or the cell that was unchargeable (charge failure). The cells that use the active materials of Examples have three YES and thus are indicated by solid circles or solid triangles in the ternary graph.

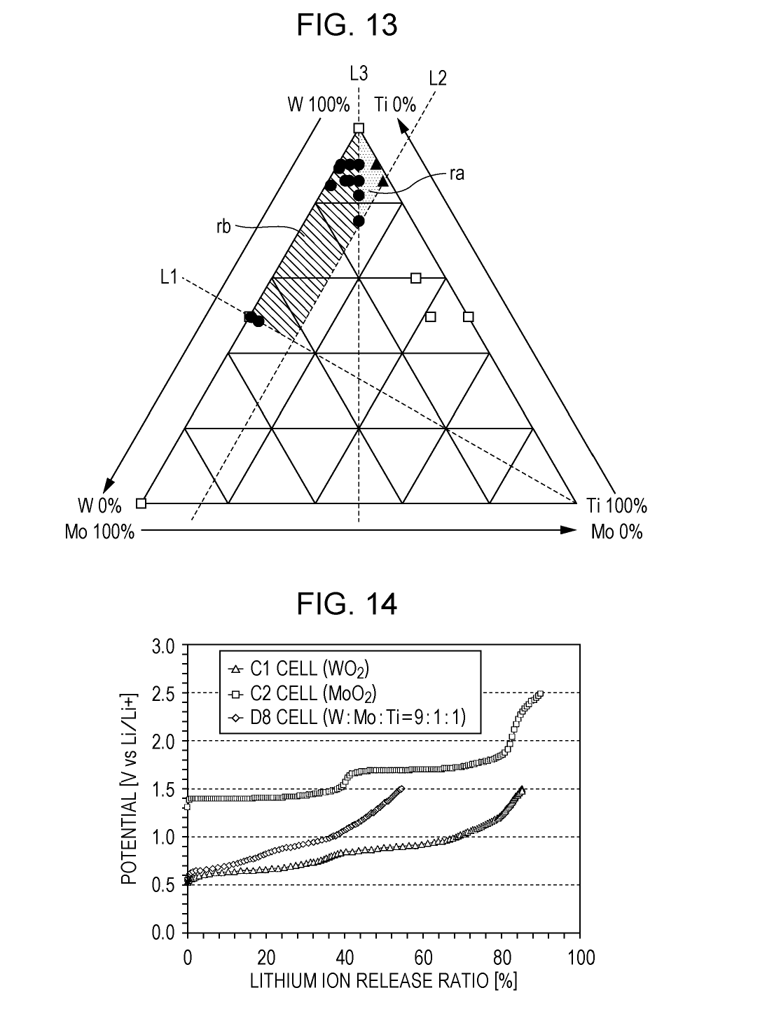

FIG. 13 is a ternary graph indicating the evaluation results of potential controllability and a range ra of x, y, and z in the composition of the active material of this embodiment. Lines L1 and L2 in FIG. 13 respectively represent y=x and z=0.1304. A line L3 represents y=z.

As previously discussed with reference to FIG. 9, the range ra in the ternary graph is the range where the W content x is on and above the line L1 (x≧y) and the Ti content z is on or below the line L2 (z≦0.1304). As apparent from FIG. 13, all active materials that have a composition within the range ra are confirmed to exhibit good potential controllability (three or more YES in the evaluation results).

It can also be understood from the ternary graph that higher potential controllability (four or more YES in the evaluation results) can be achieved in a range rb, which is a range within the range ra and has a Mo content y on or above the line L3 (y≧z). Accordingly, more notable effects can be obtained from the active materials having compositions that lie within the range rb (including points on the lines L1, L2, and L3) surrounded by the lines L1, L2, and L3.

As described by using the charge curves and the differential curves of the respective evaluation cells, the cells D2 to D6 and D8 to D16 having high potential controllability as described above all have good potential controllability during discharging as well.

FIG. 14 is a graph indicating charge curves of the cell D8 of Example and the cells C1 and C2 of Comparative Examples on the second cycle. The horizontal axis of the graph indicates the lithium ion release ratio from the time discharge is started. Since the lithium ion charge ratio at the start of discharge differs between the evaluation cells, the lithium ion release ratio from the start of discharge was calculated from the time integration of current as with the charge ratio.

As apparent from FIG. 14, the discharge curve of the cell C2 (active material: MoO₂) has a region in which the potential changes rapidly. In contrast, the discharge curves of the cells D8 and C1 are relatively gentle. In particular, the discharge curve of the cell D8 is more gentle than that of the cell C1. Although not illustrated in the drawing, the cells D2 to D6 and D9 to D16 also exhibit similar gentle discharge curves.

As discussed above, the active materials of this embodiment have charge-discharge properties in which rapid changes in oxidation-reduction potential associated with charging and discharging (intercalation and deintercalation of lithium ions) are suppressed. Accordingly, rapid changes in voltage during charging and discharging is suppressed by using an active material of this embodiment and a lithium ion secondary battery with good voltage controllability can be offered.

As apparent from FIGS. 10A, 10B, and 14, the active material of this embodiment has a low potential. Specifically, the potential region mainly involved in charging and discharging is 1.0 V or less. Thus, a lithium ion secondary battery that uses the active material of this embodiment in the negative electrode can maintain voltage between the positive electrode and negative electrode and suppress the decrease in energy density.

Table 2 also indicates the potential (denoted as “Potential I” in Table 2) at the time the potential decrease typically occurring at the early stage of charging substantially ends and the potential (denoted as “Potential II” in Table 2) at a lithium ion charge ratio of 35%. These potentials were measured during the second-cycle of charging of each evaluation cell. The potential at which the value of the differential curve of the charge curve of the second cycle became lower than 0.02 for the first time was assumed to be the potential I. The results indicate that the potentials I and II are 1.0 V or less for the cells D2 to D6 and D8 to D16.

As discussed above, a rapid change in potential during charging and discharging can be suppressed by using an active material of this embodiment. Thus, good potential controllability can be realized throughout a lithium ion charge ratio range wider than in related art. Moreover, since the change in potential in the charge curve can be decreased compared to related art, the potential controllability can be enhanced. Accordingly, a lithium ion secondary battery having good voltage control can be provided by using an active material of this embodiment. Since the oxidation reduction potential of the active material of this embodiment is 1.0 V or less, the voltage between the positive electrode and the negative electrode can be retained and the decrease in energy density can be suppressed by using an active material of this embodiment in the negative electrode to construct a lithium ion secondary battery.

An active material of a lithium ion secondary battery and a lithium ion secondary battery according to embodiments of this disclosure are used in, for example, a power supply in the environmental energy field such as a power supply for power storage or electric vehicles. The active material and the lithium ion secondary battery can also be used in power supplies of portable electronic devices such as personal computers, cellular phones, mobile appliances, portable information terminals (PDAs), portable game consoles, and video cameras. They are also expected to be used in secondary batteries that assist electric motors of hybrid electric vehicles and fuel cell automobiles, power supplies for driving power tools, cleaners, and robots, and power supplies of plug-in HEVs.

What is claimed is:

1. An active material of a lithium ion secondary battery, comprising:
a composition represented by W(x)Me₁(z₁)Me₂(z₂) . . . Meₙ(zₙ)O₂ (where x+z₁+z₂+ . . . +zₙ=1, n is an integer of 1 or more, and 0<max{z₁, z₂, . . . , zₙ}/x<1/2)
wherein Me₁ to Meₙ each represent an element that can take a rutile-type structure or a MoO₂-type structure as an oxide.

2. The active material according to claim 1, wherein Me₁ to Meₙ are n elements selected from the group consisting of Ti, V, Cr, Ge, Mn, Nb, Mo, Ru, Rh, Sn, Te, Ta, Re, Os, Ir, Pt, and Pb.

3. The active material according to claim 1, wherein the composition is represented by W(x)Ti(z₁)O₂ (where 0<z₁/x≦1/3).

4. The active material according to claim 3, wherein the composition satisfies 1/7≦z₁/x.

5. The active material according to claim 1, wherein the composition is represented by W(x)Mo(z₁)O₂.

6. The active material according to claim 5, wherein the composition satisfies z₁/x≦1/8.

7. An active material of a lithium ion secondary battery, comprising:
a composition represented by W(x)Mo(z₁)Ti(z₂)O₂ (where x+z₁+z₂=1, 0<z₁≦x, and 0<z₂≦0.1304).

8. The active material according to claim 7, wherein the composition satisfies z₂/z₁≦1.

9. A lithium ion secondary battery comprising:
a positive electrode containing a positive electrode active material that can intercalate and deintercalate lithium ions;
a negative electrode containing the active material according to claim 1; and
an electrolyte having a lithium ion conductivity and being disposed between the positive electrode and the negative electrode.

10. A lithium ion secondary battery comprising:
a positive electrode containing a positive electrode active material that can intercalate and deintercalate lithium ions;
a negative electrode containing the active material according to claim 7; and
an electrolyte having a lithium ion conductivity and being disposed between the positive electrode and the negative electrode.
